(19) United States
(12) Patent Application Publication
(10) Pub. No.: US 2025/0245374 A1
(43) Pub. Date: Jul. 31, 2025

(54) DIFFERENTIAL PRIVACY ON DATABASE SYSTEM USING STORED PROCEDURE

(71) Applicant: Snowflake Inc., Bozeman, MT (US)

(72) Inventors: Gustavo Ajzenman, Albany, CA (US); Khalid Zaman Bijon, Santa Cruz, CA (US); Liam James Damewood, Millbrae, CA (US); David Schultz, Piedmont, CA (US)

(21) Appl. No.: 18/622,438

(22) Filed: Mar. 29, 2024

Related U.S. Application Data
(60) Provisional application No. 63/626,364, filed on Jan. 29, 2024.

(51) Int. Cl. G06F 21/62

(52) U.S. Cl. CPC G06F 21/6227

(57) ABSTRACT

Various embodiments provide for using one or more stored procedures to implement differential privacy on a database system.

### CROSS REFERENCE TO RELATED APPLICATION

This application claims priority to and the benefit of U.S. Provisional Patent Application No. 63/626,364, filed on Jan. 29, 2024, which is incorporated herein by reference.

### TECHNICAL FIELD

The present disclosure generally relates to data systems and, more specifically, to implementations of database systems that use one or more stored procedures to implement differential privacy.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used for storing different types of content, such as bibliographic, full text, numeric, and/or image content. Further, in computing, different database systems may be classified according to the organizational approach of the database. There are many different types of databases, including relational databases, distributed databases, cloud databases, object-oriented databases, and others.

Data about people, such as health data, financial records, location information, web browsing, and viewing habits, is valuable for analysis and collaboration. There are many technologies in which statistical or predictive analysis of personal data is beneficial. For example, medical research institutions use medical information about populations of individuals to support epidemiologic studies. Map providers use location information gathered from mobile devices carried by people to determine traffic information and provide routing guidance. Technology companies collect information describing the behaviors of Internet users to improve their offerings, such as by redesigning user interfaces to improve human-computer interactions, making improved recommendations, and offering sponsored messages.

However, the personal nature of this data limits its usefulness. Government regulations provide strict rules about how personal data can be collected, used, and shared. Individuals also have expectations about how their personal data will be used and may react negatively if it is publicly disclosed. As a result, companies that collect and maintain personal data seek ways to extract value from it without running afoul of such rules and expectations.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, according to some embodiments of the present disclosure.

FIG. 2 is a diagram illustrating the components of a compute service manager, according to some embodiments of the present disclosure.

FIG. 3 is a diagram illustrating components of an execution platform, according to some embodiments of the present disclosure.

FIG. 4 is a simplified block diagram of an example differential privacy (DP) budget store for managing one or more DP budgets for one or more DP policies in a data system, according to some embodiments of the present disclosure.

FIG. 5 illustrates example cloning behaviors of schemas with respect to DP policies, according to some embodiments of the present disclosure.

FIG. 6 illustrates example cloning behaviors of tables with respect to DP policies, according to some embodiments of the present disclosure.

FIGS. 7 and 8 illustrate examples of implementing DP features with respect to a data system, according to some embodiments of the present disclosure.

FIGS. 9 and 10 are flow diagrams illustrating example methods for using one or more stored procedures to implement differential privacy on a database system, in accordance with some embodiments of the present disclosure.

FIG. 11 illustrates a diagrammatic representation of a machine in the form of a computer system within which a set of instructions may be executed for causing the machine to perform any one or more of the methodologies discussed herein, according to some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

One set of techniques for using personal data involves removing personally identifiable information from the data through masking, hashing, anonymization, aggregation, and tokenization. These techniques tend to be resource-intensive and may compromise analytical utility. For example, data masking may remove or distort data, compromising the statistical properties of the data. These techniques also often fail to protect individual privacy.

An additional technique makes use of Differential Privacy (DP). Differential privacy is a technology that injects noise into results provided by statistical databases to protect private information. A differentially private system provides differentially private results in response to database queries. The amount of private information provided by the system may depend, in part, on a “privacy budget” that describes the amount of privacy that may be “spent” to retrieve information from the database. The differentially private system needs to calculate privacy spend correctly because it directly impacts the analytical utility of the information in the database. It is likewise essential for the system to minimize privacy spend to the extent possible to provide a privacy budget for additional queries for the same reason.

Differential privacy (DP) technology is based on a formal mathematical framework for quantifying and managing privacy risks. It can be used to protect data against a wide range of potential privacy attacks that seek to learn sensitive information or even reconstruct exact values in the sensitive data. Differential privacy technology emerged as a tool to protect sensitive data under the release of aggregate statistics. Overall, differential privacy provides a standard for accessing data, and it is not a property of data. A computation can meet the standard of differential privacy, in which case the data is protected. Specifically, a computation (e.g., a data query) is differentially private if you cannot ascertain from the outputs of the computation (e.g., the query result) whether a specific subject in the data was present. This is equivalent to saying that if a computation is differentially private, it will not unduly reveal information specific to any data subject. A data subject can be a transaction, an individual, or more generally an entity, e.g., a company.

DP technology can permit a user (e.g., data user) of a data system to share and collaborate data sets containing sensitive information, including personally identifiable information (PH), with an analyst (e.g., analyst user), where the analyst can analyze the data without gaining direct access to the sensitive information. Generally, a data system using DP restricts direct access to an individual record of a dataset by only allowing aggregate queries to be performed on the dataset, where each aggregate queries mathematically applies noise to the result so that the user cannot gain insight about sensitive information (stored by the individual records of the dataset) from the result. In particular, the overall flow comprises: an administrator applies a differential private policy to a table in which one or more rows can comprise sensitive information (e.g., about individuals, such as a name, address, gender, age, income, occupation); and an analyst can run one or more aggregate queries against the table, such as a query for average income grouped by occupation, but cannot run any queries that target any specific record (e.g., any specific individuals).

As noted, DP technology usually implements a privacy budget, which can gate the number of queries run by a given user (e.g., analyst user).

While other privacy technologies exist, differential privacy technology has the benefit of strong, mathematically-proven privacy guarantees. Additionally, differential privacy technology is well-suited for use cases where a data consumer (e.g., analyst user) is untrusted or adversarial to a data provider or where data is shared with an untrusted analyst (e.g., intra-organization or inter-organization analyst).

As used herein, noise can comprise randomly generated noise (e.g., noise data) that is added (e.g., injected) to a result (e.g., query result) of a computation (e.g., query) to cause the result to meet a standard of differential privacy (e.g., to render the result differentially private). Noise can be drawn from a distribution (e.g., Laplace or Gaussian distribution), which can be carefully tuned to balance privacy and utility.

As used herein, a differentially private query (or differentially private query) can refer to a query to a data system that uses differential privacy. As used herein, a differentially private query result (or differentially private query result) can refer to a query result, generated by a data system that uses differential privacy, in response to a differentially private query. As used herein, utility can refer to the accuracy of a differentially private query result. Generally, high utility results from injection of low noise. As used herein, a data system (or data platform) that uses or supports differential privacy can be referred to as differential privacy (DP) data system (or DP data platform) or a differentially private data system (or differentially private data platform).

As used herein, privacy loss (also referred to as privacy risk) can comprise a quantified metric that measures the risk of a successful privacy attack (e.g., that a specific subject's data has been compromised) or tracks (e.g., tracks) how much information has been compromised (e.g., amount of information leakage). Generally, as privacy loss goes up, privacy of sensitive information goes down. As more computations (e.g., queries) are run on data whose results are released, the total privacy loss and risk increase. A data owner (or data admin) can choose a threshold (e.g., a privacy budget) of privacy loss beyond which the risk of releasing more information is too high.

As used herein, a privacy budget can comprise a threshold that limits the amount of privacy a user (e.g., analyst user) can spend on data (e.g., the user can query). A privacy budget can be expressed as a positive real number. The magnitude of noise added to a computation result (e.g., query result) can be inversely proportional to the privacy loss incurred (e.g., privacy spent). This can be referred to as the privacy-utility tradeoff. A privacy budget can be enforced in different ways. For instance, under a fixed privacy budget (or a fixed privacy budget mode), a differential privacy data system looks across all of the queries that a user has run on the table or view to calculate privacy spent. In another example, under a rolling privacy budget (or a rolling privacy budget mode), a differential privacy data system looks at recent queries that a user has run based on a rolling time window to calculate privacy spent (e.g., consider the privacy spent in the last 7 days starting from when a new query is requested).

As used herein, a privacy profile can comprise a set of privacy settings, which can be configured by, or pre-configured for, an administrator (e.g., admin user).

As used herein, trust can refer to a data provider's expectation of a data consumer's behavior. As used herein, a trust level can refer to a degree to which a data consumer is trusted with knowing the content (e.g., sensitive information) of data from a dataset. In terms of trust levels, fully trusted can refer to a degree of trust where a data provider has no concerns about a data consumer of the data knowing the content of data from a dataset. Semi-trusted can refer to a degree of trust where there is certain information in data from a dataset that a data provider would like to hide from the consumer, and the data provider has confidence the consumer will respect this boundary. Untrusted can refer to a degree of trust where there is information in the data from a data set that a data provider does not want a data consumer to access, and the data provider does not have full confidence that the data consumer will respect the boundary. At the untrusted level, there is reason to believe that the data consumer will not actively reverse engineer the sensitive information. Adversarial can refer to a degree of trust where the incentives of a data provider and a data consumer are diametrically opposed—the data consumer (or some subset of data consumers) has incentives to discover exactly the information the data provider intends to protect.

As used herein, a privacy attack can refer to a set of queries (e.g., DP queries) used to attempt to discover information (e.g., sensitive information), in private data from a dataset, to a high degree of confidence. A privacy attack can range from very naive (e.g., SELECT *) to be very sophisticated, which can require expertise in information theory. As noted herein, differential privacy (DP) was created to protect against any privacy attack known or unknown, concrete or theoretical. Relaxations in DP (e.g., on a differentially private data system as described herein) must consider whether specific types of attacks are prevented. When relaxing DP (e.g., on a differentially private data system as described herein) for use in real-world use cases, an administrator should consider how realistic a specific type of attack would be.

With respect to users of a data system (that uses or otherwise supports differential privacy) as described herein, an administrator (or admin user) can be a trusted user of the data system who has permission to manage a differential privacy configuration. An analyst (or an analyst user) can be a user who is writing a differentially private query against one or more tables protected by differential privacy. A data consumer can refer to a person who wants to see differentially private query results from a differentially private query performed against data. A data consumer is not necessarily an analyst, and a data consumer generally does not run any differentially private queries on one or more tables that are private to the data consumer.

Various embodiments described herein relate to data systems that use differential privacy. According to some embodiments, an analyst submits to a data system (e.g., data platform) a differentially private query using a software interface (e.g., Python interface), which causes the calling of one or more stored procedures on the data system, where the one or more stored procedures encapsulate a differential privacy engine (also referred to herein as a privacy engine or PE). The differential privacy engine can generate and submit a set (e.g., series) of non-DP queries to the data system, receive a set of non-differentially private query results from the data system, and generate (e.g., computes) one or more differentially private query results based on the set of non-DP queries (e.g., by generating noise, applying the noise to the set of non-differentially private query results based on one or more differential privacy policies, and charge a privacy budget).

By use of various embodiments, a policy-based differential privacy data system can be implemented where a data owner/steward can selectively protect data based on roles/users of a single account or across different accounts when sharing data within the data system. Using various embodiments, analysts do not need to specify to a differential privacy data system any data privacy configuration while running a query but, rather, can just execute aggregate queries on the differential privacy data system, and one or more differential privacy policies can ensure the data is protected. By use of various embodiments, a differential privacy data system can systematically return a randomization interval for a query, which the analyst can use to verify the accuracy of the result. Additionally, by use of various embodiments, a differential privacy data system can permit an admin to specify privacy domains (e.g., bounds) to exclude any outliers (e.g., outlying data points) from a dataset being queried.

According to some embodiments, a differentially private data system provides differential privacy (DP) administration, which permits an administrator (e.g., admin user, such as a security admin user) to configure fine-grained access control based on flexible access policies (e.g., customer-defined access policies). Compared to using row-level security and masking, differential privacy (DP) policies introduce a privacy budget, randomization, or both, which can limit privacy loss (e.g., privacy exposure) of entities in a dataset to users (e.g., untrusted users). For some embodiments, the differentially private data system restricts what users can query from the database and can apply differential privacy (DP) at the granularity of tables or views by applying one or more DP policies to a table or a view, thereby protecting rows of data contained therein. DP protection can be defined over a window of time defined by an administrator. DP can grant a privacy budget per user in a data provider's account or per a consumer account in data sharing (e.g., private sharing). For some embodiments, the differentially private data system separates management of data and DP policies. In this way, an administrator can avoid having to define new secure views every time the schema of the data changes, and users can avoid needing to figure out which of multiple views gives them the appropriate access to an underlying table.

Depending on the embodiment, an administrator can grant permission to a data user (e.g., data steward) to manage a differential privacy (DP) configuration. A customer can programmatically define their own logic regarding DP, thereby providing extensibility. A DP policy can leverage policy concepts and syntax similar to other policies, such row-level security and column masking policies. An administrator can prevent users from observing both logic of a DP policy and mapping tables that implement restrictions (e.g., DP restrictions, such as policy conditions) of the DP policy. A given DP policy can apply to multiple tables and views with scalability (e.g., 100k+ tables and views). To facilitate this, an embodiment can use one or more stored procedures to share logic of a DP policy across multiple tables or view using. For audit or debug purposes, an administrator can examine an inventory of available DP policies, can examine a set of tables to which the DP policies are applied to, can examine the history of changes in the DP policies, can show a privacy budget for a table or a view, and can identify which tables each use has DP access to.

Depending on the embodiment, an administrator can configure entity-level or row-level differential privacy (DP), with the latter being facilitated by way of an entity identification function. DP data access can be configured using Role-Based Access Control (RBAC). Some embodiments can provide DP-protected data to data shares, which facilitate DP data sharing. An administrator can grant a user full access to DP-protected data (e.g., as one role of the user), DP-access to DP-protected data (e.g., as another role of the user), or both (e.g., for certain use cases in which a data provider is creating a privacy-preserving data product for data consumers using DP).

For some embodiments, an administrator can explicitly identify one or more entities to a differentially private data system that should be protected by differential privacy (DP). For some embodiments, a differentially private data system can support differentially private machine learning (ML) workflows. Additionally, for some embodiments, a differentially private data system can automatically provide high-utility results for every differentially private query by a differentially private query optimizer, which can optimize the differentially private query to maximize utility while meeting a differential privacy (DP) standard.

For various embodiments, an analyst can directly query differential privacy (DP)-protected data as an untrusted party (rather than interacting with results produced by a trusted analyst). An analyst can view their privacy budget consumption, while being prevented from managing the privacy budget. For some embodiments, a differentially private data system permits an analyst to contextualize the amount of noise in a differentially private query result produced by a differentially private query. For instance, a differentially private query result can include noise, and a differentially private data system can provide a randomization interval, which comprises an estimate of magnitude of noise around differentially private query results. A differentially private data system can generate an error message to a query from an analyst for various reasons, such as running a non-differentially private query on DP-protected data, or the query exceeding the analyst's privacy budget.

Depending on the embodiment, a differentially private data system can provide a software interface (e.g., application programming interface (API), such as a Python API) to provide DP access (e.g., submit DP queries and receive differentially private query results) to DP-protected data, or can support DP access to DP-protected data through structured query language (SQL).

With respect to privacy budget, a differentially private data system can permit an administrator (e.g., privacy budget admin user) to automatically block intra-account users and external accounts from running differentially private queries that would exceed their respective privacy budget. Each intra-account user can have a privacy budget for each DP-protected table and view. For external accounts, a data provider account will likely not have access to users and, as such, all users in an external account can share a privacy budget, in both intra- and inter-organization data sharing cases. For inter-organization data sharing, an administrator can assume collusion: if the data provider is sharing data inter-organization, the data provider should assume that the users in one account will share results with each other.

An administrator can explicitly protect data in tables and views with differential privacy (DP). For instance, an administrator can indicate that data needs to be protected by DP in tables, views, or both. Consumption of a privacy budget can be tracked on (user, table/view) for intra-account users and on (account, table/view) for external accounts. According to some embodiments, a table or a view that has DP protection (e.g., as explicitly indicated by an administrator) has a privacy budget. An analyst will be blocked from creating a view on a DP-protected table or a DP-protected view. For some embodiments, views that an administrator creates on top of a DP-protected table or DP-protected view will not be protected until they are explicitly DP-protected by the administrator.

For some embodiments, an administrator manages levels of access for differential privacy (DP)-protected data by user, role, account, or some combination thereof. An administrator can change a setting by (user, table/view) or (external account, table/view) for a privacy budget or for a privacy budget mode. An administrator may want to change these settings to enable an analyst to continue running DP queries after they have exhausted their privacy budget, or to provide different users different privacy budgets depending on their level of trust.

Some embodiments enable an administrator to differential privacy (DP)-protect data that is being mutated (e.g., updated over time). Privacy budgets can be tracked at a table level, meaning that when rows of a table are changed or added to the table, neither the total privacy spent nor the privacy budget change. One way of interpreting this is that new rows come in as if they have already had some privacy budget spent on them. For some embodiments, a differentially private data system can optimize privacy spend for data that is mutating by tracking increased privacy protection on data that is added to a DP-protected table, and trading off utility with the increased privacy protection.

For various embodiments, an administrator can configure use cases with a mix of private and non-private data. Some real-world use cases for differential privacy (DP) can involve both private and non-private data. In some cases the private and non-private data can be in separate sources (e.g., separate tables that are joined), and in some cases the private and non-private data could be mixed in one table. For some embodiments, an analyst can run a differentially private query on this combination while only being potentially gated by privacy budget on the private data.

Various embodiments cause a differentially private data system to automatically DP protect data in views with an upstream privacy budget source. For instance, if an administrator has placed DP protection on view A, and then created view B using view A, some embodiments can automatically cause view B to be DP protected (based on the presumption that view B still has the sensitive information). For some embodiments, view B would not need its own privacy budget per user/external account; the differentially private data system can have DP queries on view B charge privacy budget to view A. According to some embodiments, an administrator can configure a differentially private data system to automatically DP protect copies generated from DP-protected data, such as copies generated using clone or replicate operations.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

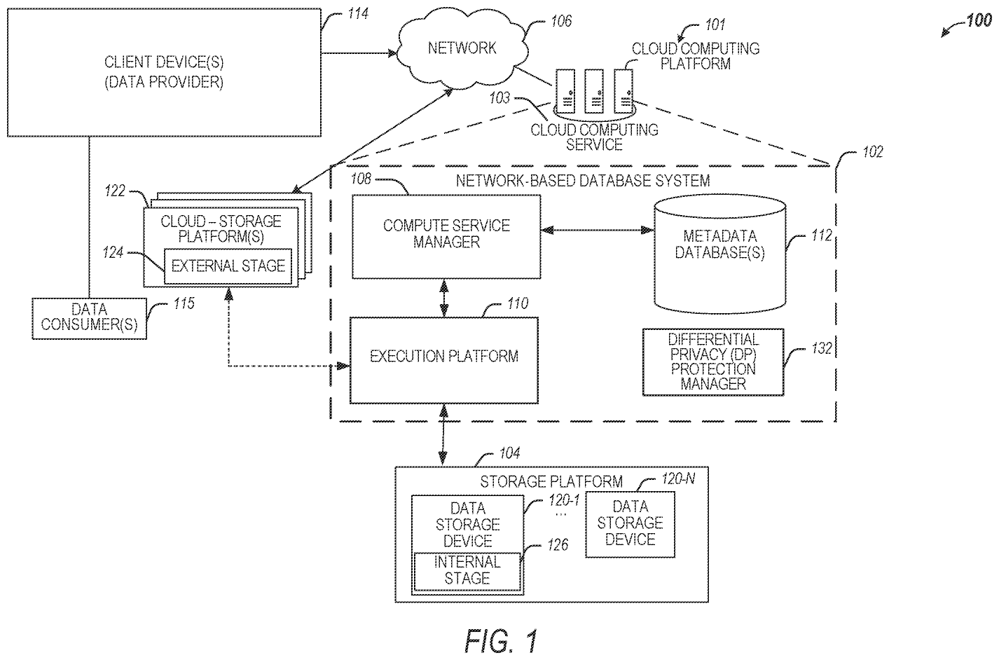

FIG. 1 illustrates an example computing environment 100 that includes a database system in the example form of a network-based database system 102, according to some embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some embodiments, the computing environment 100 may include a cloud computing platform 101 with the network-based database system 102, and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., configuring replication group objects as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage). The network-based database system 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112.

The network-based database system 102 hosts and provides data reporting and analysis services to multiple client accounts.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based database system 102. A user may utilize the client device 114 to submit data storage, retrieval, and analysis requests to the compute service manager 108. Client device 114 (also referred to as remote computing device or user device 114) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 101 (e.g., cloud computing service 103) by way of a network 106, such as the Internet or a private network. A data consumer 115 can use another computing device to access the data of the data provider (e.g., data obtained via the client device 114).

In the description below, actions are ascribed to users, particularly consumers and providers. Such actions shall be understood to be performed concerning client devices (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some embodiments, metadata database 112 is configured to store account object metadata (e.g., account objects used in connection with a replication group object).

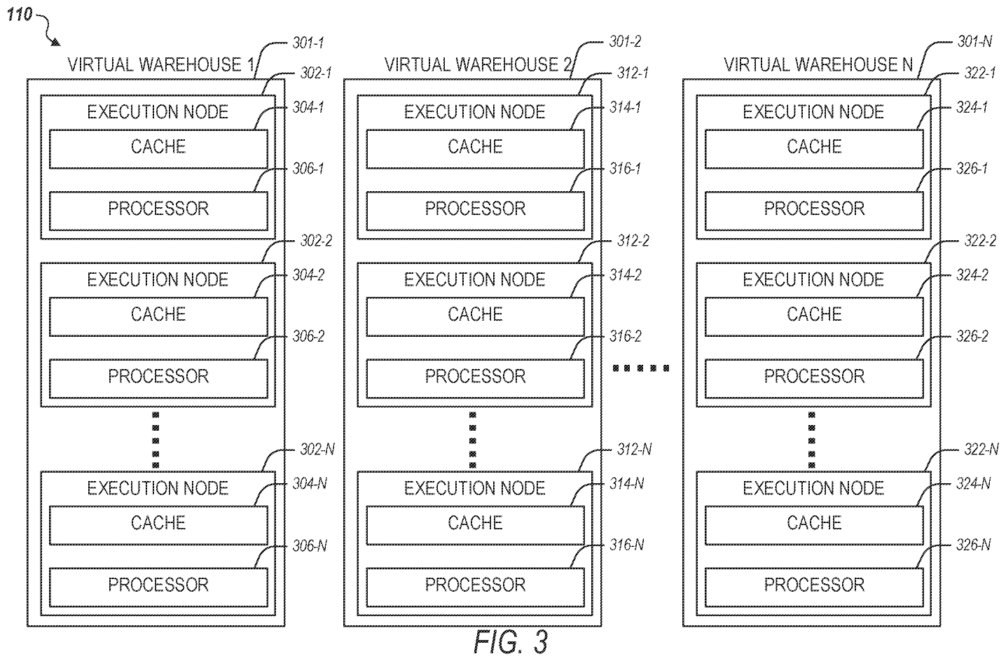

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3® storage systems, or any other data-storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

The compute service manager 108, metadata database(s) 112, execution platform 110, and storage platform 104, are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

In some embodiments, the network-based database system 102 includes a differential privacy (DP) protection manager 132. The DP protection manager 132 comprises suitable circuitry, interfaces, logic, and/or code and is configured to facilitate differential privacy (DP) features with respect to one or more objects (e.g., tables or views of the network-based database system 102) according to various embodiments. The following describes one or more features of DP implemented by the differential privacy (DP) protection manager 132 on the network-based database system 102, or some other data system.

With respect to implementation, a differentially private data system can support one or more of the following methods to support implementation of a differential privacy (DP) policy (also referred to herein as a privacy policy).

TABLE 1

| Method | Description |
|---|---|
| validatePolicyBody | Static method that checks that sqlNode in input |
| | has a body, which does not refer to UDFs or |
| | external objects. This is a static method so it |
| | won't check invariants of the instance. |
| validatePolicyCreation | Static method called at privacy policy creation |
| | time. It checks that the body returns a string and |
| | that the signature of the policy is correct; |
| | nullary, and returns a string. |
| validateAttachPoli- | Checks that the entity to which the privacy |
| cyAction | policy is attached is supported. (Tables/Views) |
| clonePolicy | Clones that privacy policy into a new object. |
| | This can include when a data object is replicated |
| | from one deployment to another deployment - |
| | the same policy will protect the replicated |
| | object. |

A DP policy can be applied to any object that store data in tabular format, including both tables and views (e.g., materialized views, external tables), and protect the rows of the data in the object. Protection can be defined over a window of time defined by an administrator. A DP policy can be created (e.g., by an administrator) using: CREATE PRIVACY POLICY <name> AS ( ) RETURNS privacy_budget-> <expression> [COMMENT=‘<string_literal>’]. The expression can be any privacy budget-valued SQL expression. This can provide two ways to specify the privacy budget: (a) privacy budget(budget_name:str) where budget_name is a unique identifier for budget name; and (b) no_privacy_policy( ) indicates that the policy allows for full access (SELECT) to the data. DP policy can enable a privacy engine of a differentially private data system to read sensitive data on behalf of users when a policy expression is evaluated. If the return value of the expression is NULL, this can highlight an error in how the privacy body was compiled and the differentially private data system can fail with a compilation error (in which case, no DP queries can be run on the entity to which the DP Policy is associated). When the privacy engine wants to execute a differential privacy (DP) query on behalf of a role, a DP policy can be consulted to determine which budget to use.

For some embodiments, enforcement of a differential privacy (DP) policy is performed on a differential privacy (DP) query comprising SELECT < > FROM < >. The DP policy may not be enforced if the DP policy was assigned to an underlying table/view as opposed to the view/table over which the user runs the differentially private query. The following shows how a DP policy would be evaluated and enforced in the scenario where we have a base Table T and a View V defined on Table T.

```
Set-up:
  • Table T
  • View V defined on Table T
  • INVOKER_ROLE( ) = V −> the invoker role for View V
  • P1 = privacy policy attached to Table T
  • P2 = privacy policy attached to View V
  • P1 could be the same as P2, or not
  • B1 = privacy budget returned by P1
  • B2 = privacy budget returned by P2
Query run:
  • SELECT <something> FROM V ...
```

For the above, if a role A queries a table, the invoker_role would indicate A if the INVOKER_ROLE( ) context function is used in the policy. However, assume a view V on table T, and view owner is R2 and the policy is attached to table. Now, if role R1 queries on the view V, the INVOKER_ROLE( ) context function would return R2 (view owner's role). The below TABLE 2 describes a functional specification, from which the conditions necessary to run a query through a privacy engine of a differentially private data system can be inferred. Based on TABLE 2, if there is a simple Table T on top of which a user wants to run a query, then the Table T can have a DP policy attached to it that evaluates to an actual PrivacyBudget. If the DP policy evaluates to a no_privacy_policy( ) then the query cannot be run through the privacy engine. If there is a View V on top of a table, then the table either needs to have no DP policy attached to it or return a no_privacy_policy( ) for the invoker of View V. Additionally, in order to run a query on View V through the privacy engine, View V needs to have a DP policy attached to it that evaluates to an actual budget. In any chain of data derivation, there may only be one valid PrivacyBudget active at a time and that budget would be attached to the entity on which the query is run.

TABLE 2

| | Evaluation | | |
|---|---|---|---|
| Evaluation of | of P1 on T | Result of PE | |
| P2 on V with | with invoker | running | Result of |
| analyst role | role | query on V | regular SQL |
| X(not attached) | X (not | X (nothing to | Query Can |
| | attached) | charge) | Run |
| X (not attached) | no_privacy_policy( ) | X (nothing to | Query Can |
| | | charge) | Run |
| X (not attached) | budget | X (because PE | X |
| | | can't evaluate | (because P1 |
| | | views) | evaluates to an |
| | | | actual budget) |
| X (not attached) | NULL | X (because P1 | X |
| | | is invalid) | |
| no_privacy_policy( ) | X (not | X (nothing to | Query Can |
| | attached) | charge) | Run |
| no_privacy_policy( ) | no_privacy_policy( ) | X (nothing to | Query Can |
| | | charge) | Run |
| no_privacy_policy( ) | budget | X (because PE | X (because P1 |
| | | can't evaluate | evaluates to an |
| | | views) | actual budget) |
| no_privacy_policy( ) | NULL | X (because P1 | X (because P1 |
| | | is invalid) | is invalid) |

Some embodiments enforce a rule that where if a query is run on a View V2 e.g., SELECT COUNT(*) FROM V2, then a differentially private data system can only have a differential privacy (DP) policy that evaluates to an actual privacy budget attached only to the View V2. Everything else on a derivation path of View V2 must have no DP policy attached or the DP policies attached to those entities can evaluate to no_privacy_policy( ). For example, where View V2 is a view created on top of View V1, which is a view created on top of Table T (so T->V1->V2) and there are DP policies PPT, PP1, and PP2 attached to entities T, V1 and V2 then only PP2 would be evaluated to an actual privacy budget, and PPT and PP1 would evaluate to no_privacy_policy( ) else otherwise there would be an error. This can be implemented by visiting children first, and keeping track of the objects that have attached a DP policy that evaluates to an actual privacy budget through a set objectsWithPrivacyBudget. This can be done so that a derivation chain V2 created from V1 created from T can only have one single valid privacy budget attached to the chain. Since children are visited first, some embodiments use a stack to keep track of the current query and entities that are being looked at and recurse back to the parent query. A data derivation path can be considered any derivation branch that starts at a base table and continues with views e.g., Table T base table, then creating view V from T creates the branch T->V.

For example, for an example query SELECT <SOMETHING> FROM V2, PPV2 attached to View V2 can evaluate to no_privacy_policy( ), PPV2 attached to View V2 can evaluate to PrivacyBudget(2.0), PPV1 attached to View V1 can evaluate to no_privacy_policy( ), and PPT1 attached to Table T can evaluate to no_privacy_policy( ). According to various embodiments, in the case of views, only the topmost can evaluate to an actual PrivacyBudget and everything view/table underneath can return a no_privacy_policy( ).

The following provides an example pseudocode for implementing policy enforcement.

TABLE 3

```
queryStack = new Stack( );
private Set<SqlNode> objectsWithPrivacyBudget = new
HashSet<>( );
-- add each of the SELECT statements that may contain
a Table/View to a stack
-- we go depth first to the children and then we
reverse back Procedure 1.
  for each queryBlock
  if we have a new queryBlock and the queryBlock is
  a select statement:
    *queryStack.add(queryBlock)
    *visit the queryBlock
    *queryStack.pop( )
-- for each SqlFrom node
Procedure 2.
if we have a privacy policy that evaluates to and
actual PrivacyBudget for current
object:
  if this object is a View:
    * check if any of the
  objects from which the View derives
  are in objectsWithPrivacyBudget and
  if they are throw an error
  * add the
  object to the
  objectsWithPrivacyBudget
  set
  (objectsWithPrivacyBudge
  t.add(object))
else we have a privacy policy that evaluates to
no_privacy_policy( ) OR we don't have a privacy policy
attached
  if this object is a System Generated View:
    * then check if any of
the objects from which the System Generated
View is derived have a privacy policy that
evaluate
      to a privacy budget, if so
    then we propagate the status up to
    the System Generated View by
    adding it to
    objectsWithPrivacyBudget
  else if this object is a View but not a System
  Generated View
    * check if any of the
  objects from which the View derives
  are in objectsWithPrivacyBudget and
if they are throw an error
```

The following is an example scenario and a run-through of the pseudocode. Assume a data derivation chain of Table T->View V1->View V2->View V3. In this chain, assume a differentially private data system runs a SELECT AVG(*) FROM View V3 query. According to some embodiments, a privacy engine of the differentially private data system can process the query: all the entities up to View V3 e.g. [T, V1, V2] can have differential privacy (DP) policies that evaluate to no_privacy_policy( ) or can have no privacy policy attached to it; or View V3 can have a privacy policy that evaluates to an actual PrivacyBudget.

As a first example, a user can create a test table, create a test_view on top of the test table, add a privacy policy test_policy to table test, and add a privacy policy test_view_policy to the test_view table. Test-view-policy can evaluate to an actual privacy budget, and test_policy can evaluate to no_privacy_policy( ) for the owner of the view. The following illustrates this example.

TABLE 4
CREATE TABLE test(...);
CREATE test_view as select * from test;
CREATE PRIVACY POLICY test_policy AS ( ) RETURNS string
−>
CASE WHEN INVOKER_ROLE( ) in (‘OWNER_OF_TEST_VIEW’)
then
‘no_privacy_policy( )’ ELSE ‘Budget1’
END;
CREATE PRIVACY POLICY test_view_policy AS ( ) RETURNS
string −> ‘Budget2’; alter table test add privacy policy
test_policy;
alter view test_view add privacy policy
test_view_policy;
-- the query we are running
SELECT count(*) FROM test_view; -- should be able to run
the query

As a second example, a user can create a test table, create a test_view on top of the test table, create a double_test_view on top of the test_view table, add a privacy policy test policy to table test, add a privacy policy test_view_policy to the test_view table, and add a double_test_view_policy to the double_test_view table. Test_policy can evaluate to an actual privacy budget, and test-policy can evaluate to no_privacy_policy( ). Test_view_policy can evaluate to no_privacy_policy( ) for the owner of the double_test_view and an actual privacy policy in any other case. Double_test_view_policy can evaluate to an actual budget. If a query is run on the double_test_view table, the query should pass.

TABLE 5
CREATE TABLE test(...);
CREATE test_view as SELECT * from test;
CREATE double_test_view as SELECT * from test_view;
CREATE PRIVACY POLICY test_policy AS ( ) RETURNS string
−> ‘no_privacy_policy( )’; CREATE PRIVACY POLICY
test_view_policy AS ( ) RETURNS string −>
CASE WHEN INVOKER_ROLE( ) in
(‘OWNER_OF_DOUBLE_TEST_VIEW’) then
‘no_privacy_policy( )’ ELSE ‘PrivacyBudget2’ END;
CREATE PRIVACY POLICY double_test_view_policy AS ( )
RETURNS string −> ‘PrivacyBudget3’;
alter table test add privacy policy test_policy;
alter view test_view add privacy policy
test_view_policy;
alter view double_test_view add privacy policy
double_test_view_policy;
-- the query we are running
SELECT count(*) FROM double_test_view; -- should be able
to run the query

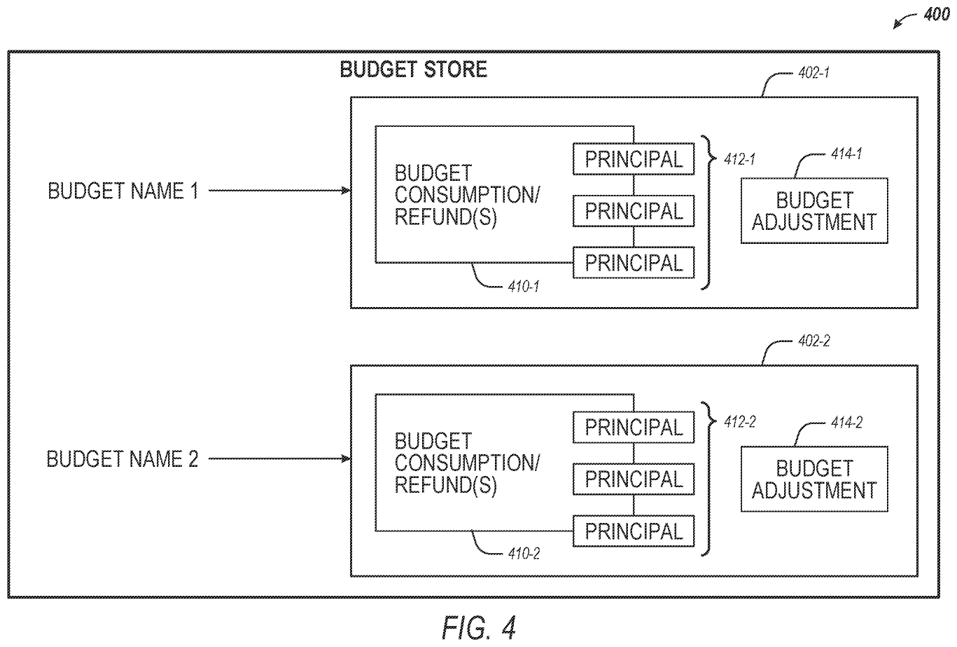

The DP protection manager 132 can manage one or more privacy budgets associated with differential privacy (DP) policies using a budget store. More regarding this is illustrated and described with respect to FIG. 4.

When a user runs a query on a table or view protected by a differential private (DP) policy, the query can fail because they should not have full access to the data. When a user runs a query (e.g., differentially private query) that passes through a privacy engine of a differentially private data system on a table protected by the DP policy, the expression of the DP policy can be evaluated using the permissions of the privacy engine role, not the role of the user who ran the query. In order to understand how the queries (e.g., SQL queries) can be executed on behalf of an analyst in conjunction with the privacy engine privilege PRIVACY ENGINE ROLE in accordance with TABLE 6.

TABLE 6

| | | Policy | PRIVACY | |
|---|---|---|---|---|
| Case | | evaluation | ENGINE | Result of SQL |
| no | Who | result | ROLE | query |
| 1 | Anyone | No Privacy Policy | False | The SQL query |
| | Except | Attached | | is run as usual |
| | Privacy | | | |
| | Engine | | | |
| 2 | Anyone | Privacy Policy | False | The SQL query is |
| | Except | Attached but | | blocked and an |
| | Privacy | evaluates to NULL | | error is thrown |
| | Engine | | | |
| 3 | Anyone | Privacy Policy | False | The SQL query |
| | Except | Attached and | | is run as usual |
| | Privacy | evaluates to | | |
| | Engine | no_privacy_polic y( ) | | |
| 4 | Anyone | Privacy Policy | False | The SQL query |
| | Except | Attached and | | is blocked |
| | Privacy | evaluates to | | |
| | Engine | privacy_budget | | |
| 5 | Privacy | No Privacy | True | The SQL query |
| | Engine | Policy Attached | | is blocked |
| 6 | Privacy | Privacy Policy | True | The SQL query is |
| | Engine | Attached but | | blocked and an |
| | | evaluates to NULL | | error is thrown |
| 7 | Privacy | Privacy Policy | True | The SQL query is |
| | Engine | Attached and | | blocked |
| | | evaluates to | | |
| | | no_privacy_polic y( ) | | |
| 8 | Privacy | Privacy Policy | True | The SQL query is |
| | Engine | Attached and | | run and the |
| | | evaluates to | | privacy budget |
| | | privacy_budget | | DPOs are updated |

Context functions such as CURRENT_ROLE( ) and INVOKER_ROLE( ) can be used in the policy expression. CURRENT_ROLE( ) can return the role that executed the query, and INVOKER_ROLE( ) can be used in cases where a DP-protected table is accessed through a view, and INVOKER_ROLE( ) can return the role that owns the view.

With respect to commands and syntax that can be used by a user (e.g., administrator), the following TABLE 7 comprises one or more examples data definition language (DDL) for administration of a differentially private data system in accordance with various embodiments described herein.

```
TABLE 7
Creating a Policy
The security admin defines a differential privacy policy using the following syntax:
  CREATE PRIVACY POLICY <name> AS ( )
  RETURNS privacy_budget −>
  <expression> [ COMMENT =
  ‘<string_literal>’ ]
Creating a policy requires CREATE PRIVACY POLICY privilege on the
schema. Policy modifications follow a similar pattern.
The expression can be any privacy_budget-valued SQL expression. The expression
must be constant-foldable, and may not include UDFs and subqueries that are not
constant-foldable.
If the return value is NULL then queries on objects protected by this policy fail
with a compilation error. The expression cannot return a literal constant of NULL.
The security admin can use context functions available today for other kinds of
policies including
•CURRENT_USER( ), CURRENT_ROLE( ) IS_ROLE_IN_SESSION( ),
•INVOKER_ROLE( ) and IS_GRANTED_TO_INVOKER_ROLE( )
•INVOKER_SHARE( )
The privacy_budget type
The privacy_budget type maps to a specific budget and controls the data access.
There are two ways to specify a privacy_budget: privacy_budget and
no_privacy_policy.
The privacy_budget has one argument to specify the name of the budget used for
the policy.
  privacy_budget(
  budget_name: str -- unique identifier for the
  privacy budget.
  )
no_privacy_policy takes no arguments and indicates that the policy allows for full
access (SELECT) to the data.
  no_privacy_policy( )
The privacy_budget type cannot be null. This means that privacy policies cannot
explicitly or implicitly return null. The policy creation / policy body altering will
fail if any clause returns null or if there is no else clause.
Dropping a Policy
When policies are dropped, the budgets are garbage-collected when not within the
failsafe window. The privacy budget state including privacy spent can be manually
reconstructed using information captured in the DP ledger.
Applying a Policy
Once a policy is defined, it can be attached to one or more objects using the
following syntax:
  ALTER [ TABLE | [MATERIALIZED]VIEW ] [ IF EXISTS ]
  <name>
  ADD PRIVACY POLICY <policy_name>
Attaching a policy on a table requires either:
```

| | |
|---|---|
| (a) | APPLY PRIVACY POLICY privilege on the account, or |
| (b) | OWNERSHIP privilege on the table and APPLY privilege on the policy |

```
object.
Policy attachment is also subject to the following restrictions:
•Privacy profiles can only be applied to tables or [materialized] views.
•Multiple privacy profiles can be attached to a given table to support multi-entity
use-cases.
The syntax ADD PRIVACY POLICY indicates that the policy is a privacy policy.
Privacy policies allow the privacy engine to read sensitive data on behalf of users
when the policy expression is evaluated.
Normal RBAC policies determine which tables are queryable before privacy
policies are considered. For new tables, it's recommended to attach the appropriate
privacy policy before granting SELECT privilege broadly.
Detaching a Policy
A policy can be detached from a table with the following syntax:
  ALTER [ TABLE | [MATERIALIZED] VIEW ] [ IF EXISTS ]
  <name>
  DROP PRIVACY POLICY <policy_name>
Detaching a policy on a table requires either:
```

| | |
|---|---|
| (c) | APPLY PRIVACY POLICY privilege on the schema, or |
| (d) | OWNERSHIP privilege on the table and APPLY privilege on the policy |

```
object.
It is an error to attempt to drop a privacy policy attachment that doesn't exist. This
is consistent with the behavior of other DROP commands.
Replacing a Policy
A privacy policy p1 applied to a table can be replaced with a different policy p2
atomically as follows:
  ALTER TABLE <name> DROP PRIVACY POLICY p1 ADD
  PRIVACY POLICY p2
Altering a Policy
Once a privacy policy is defined, it can be altered, meaning the expression or the
comment associated with it can be changed. The syntax follows:
  ALTER POLICY [ IF EXISTS ] <name> SET BODY =
  <expression>
  ALTER POLICY [ IF EXISTS ] <name> SET COMMENT =
  ‘<string_literal>’
  ALTER POLICY [ IF EXISTS ] <name> UNSET COMMENT
```

With respect to privacy budget behavior, a privacy budget for a differential privacy (DP) policy can be referenced (e.g., budget store 400 of FIG. 4) by name using the system$reference function. For example, policy_reference=system$reference(‘POLICY’, ‘<policy_name>’, true, ‘INSERT’). A function can make use of a reference to modify the privacy budget (e.g., within the budget store 400 of FIG. 4). When the privacy budget is exceeded by an analyst query, the analyst query fails.

To view a particular privacy budget, an administrator can query current budget spending via a view, such as:

SELECT * FROM data_privacy.budgets WHERE
policy_name=’<policy_name>’ AND
budget_name=′<budget_name>′;

This view can provide global visibility within an account, and can be accessible only to a user with a role comprising a PRIVACY_VIEWER DB role. Since the budget_name can be determined dynamically, only budgets with spend>0 may appear in the output. The view can have a schema as described by TABLE 8.

TABLE 8

| Column name | Type | Description |
|---|---|---|
| policy_db | String | The database of the privacy |
| | | policy |
| policy_schema | String | The schema of the privacy |
| | | policy |
| policy_name | String | The name of the privacy |
| | | policy |
| budget_name | String | The name of the budget |
| account_id | Long | The principal account id |
| global_account_id (?) | Long | The global account id of the |
| | | consumer account. |
| budget | Float > 0 | The budget limit applied to |
| | | the analyst. |
| window | Int > 0 | Enum for DAILY, WEEKLY, |
| | | MONTHLY, |
| | | YEARLY, NEVER. |
| | | (Same resolutions as |
| | | resource monitoring/cost |
| | | governance) |
| window_offset | Timestamp | Timestamp truncated to the |
| | | window provides an offset of |
| | | when the window period |
| | | starts. |
| spend | Float >= 0 | Privacy spent within the time |
| | | window. This value is |
| | | computed from internal |
| | | implementation details, |
| | | including RDP curves and |
| | | refunds applied to the |
| | | account. This is the |
| | | consumption of the principal |
| | | minus any refunds applied to |
| | | the account_id. |

With respect to increasing a privacy budget, a user with a role with OWNERSHIP on the privacy policy can set the privacy budget to a new value only for budgets applicable to a given policy. For example:

CALL privacy.budgets!set_budget(
<policy_reference>, <budget_name>, <budget_value>);

Calling this method can result in a new privacy budget and window values appearing in a privacy.budgets view. If either privacy budget or window are Null, the respective value remains unchanged.

With respect to privacy budget refresh, at the end of a window, privacy spend of a given privacy budget (of a given differential privacy (DP) policy) can be reset to 0. This can enable an administrator to permit a query (e.g., differentially private query) to continue on data that is updating continually without having to manually increase the privacy budget.

With respect to privacy spent reset, refunds can be used to reduce the overall spend by an account if an administrator determines that an analyst has mistakenly spent the privacy budget. Refunding an amount to a privacy budget is not identical to increasing a limit of the privacy budget. A privacy spend method can enable an analyst account more privacy budget before the end of a budget window without changing a global privacy budget definition. The amount spent by a principal account can be found using a data_privacy.budgets view. As an example, an administrator can call the following reset function to refund the privacy budget spent.

CALL privacy.budgets!reset(
<policy_reference>, <budget_name>,
<global_account_id>);

Calling this method can result in a spend value in the privacy.budgets view decreasing by a refund amount, or being set to zero if a refund is larger than a current spend. A user having a role with OWNERSHIP on a differential privacy (DP) policy can decrement privacy spent by a principal only for privacy budgets applicable to a given DP policy.

While refunding an amount to a privacy budget is not the same as increasing a limit of a privacy budget, there can be multiple scenarios where a limit (budget limit) of a privacy budget can be adjusted. For one example scenario, an administrator may want to correct a mistake an analyst made during a current budget window and can issue a refund to the privacy budget. For example, on a month-long budget window, data may be discovered to be corrupted and the administrator does not want to penalize the analyst for bad DP queries they ran. In another example scenario, an administrator can find there is insufficient privacy budget for an analyst to perform their task. Regardless of the scenario, a refund amount is applied against privacy loss consumed in the current budget window. The refund can be forgotten outside of the budget window it is defined in. The refund can be smaller than the current budget window consumption.

A privacy_budget( ) function can take two arguments “domain” as a budget-type and “principal-name” as the budget-name in order to avoid name conflict across different principal types (e.g., user and role) since names of the principals can have conflict across domains. An administrator can conveniently use relevant context function and domain to specify such as privacy_budget(‘USER’, CURRENT_USER( )) and privacy_budget(‘ROLE’, CURRENT_ROLE( )) can be specified to specify privacy budgets for all the users and roles respectively.

According to some embodiments, a privacy budget name is specified by a single string literal as privacy_budget(‘<budget-name>’), where an administrator can do the following: specify a custom budget name when needed; and use context-function and respective domain as the prefix if the administrator wants a separate privacy budget per user (e.g., privacy_budget(‘user’+CURRENT_USER( )). If an administrator specifies a privacy budget per user as privacy_budget(‘user’+CURRENT USER( )), the number of budgets can grow with the increasing access of the different users on the tables that a differential privacy (DP) policy protects. If a DP policy is not deleted, those privacy budgets may not be deleted until there is a cleaning of the privacy budgets. Alternatively, an embodiment can limit the number of privacy budgets that can be created and give an API to delete obsolete ones so that users can create new privacy budgets within the limit.

In terms of user experiences, an administrator can share tables with row-level differential privacy (DP) access to a user, a role, or an account. For example:

CREATE PRIVACY POLICY patients_policy AS ( ) RETURNS
privacy_budget −>
CASE WHEN IS_ROLE_IN_SESSION(′DATA_ADMIN′) THEN
no_privacy_policy( )
WHEN IS_ROLE_IN_SESSION(′CLAIMS_ANALYST′) THEN
privacy_budget(budget_name=>’USER’+CURRENT_USER( ))
WHEN CURRENT_ACCOUNT( ) = ′PFIZER′ THEN
privacy_budget(budget_name=>′ACCOUNT.′
|| CURRENT_ACCOUNT( ))
END;
ALTER VIEW patients ADD PRIVACY POLICY
patients_policy;

An administrator can share tables with a single-entity differential privacy (DP) access to a user, a role, or an account. For example:

CREATE VIEW drugs_per_patient (patient_id,
tot_drug_1, tot_drug_2) AS
SELECT *
FROM rx_prescriptions
PIVOT (SUM(dose) FOR drug_id IN (‘drug_1’,
‘drug_2’)) AS p
GROUP BY patient_id

An administrator can share tables with multi-entity differential privacy (DP) access to a user, a role, or an account. For each entity, an administrator can create a differential privacy (DP) policy and apply it to one or more tables/views that have the entity's information.

An administrator can check how much total budget is used by a user, a role, or an account. For example, the administrator can inspect a differential privacy (DP) policy and understand what privacy budget is attached to a query. After they do this, they can query the table as follows:

SELECT * FROM data_privacy.budgets
WHERE policy_name=’<policy_name>’ AND
budget_name=′<budget_name>′;

An administrator can how much privacy budget is consumed per query by a user. For example, an administrator can query an ACCOUNT_USAGE view for this.

Regarding auditing and debugging, a SHOW PRIVACY POLICIES command can produce a list of policies. information_schema.policy_references can make policy associations available in a format that can be queried. Additionally, DESCRIBE POLICY command can show the policy body of a differential privacy (DP) policy. To determine changes to a DP policy, an administrator can access an ACCOUNT_USAGE view, such as PRIVACY_POLICIES, to query privacy policy history. A time travel or a stream can capture historical data about any mapping tables referenced in their security policies. An administrator can use a budgets data_privacy view to see all privacy budgets of a DP policy. For example:

SELECT * FROM data_privacy.budgets where
policy_id=<...>

To determine whether a table is protected by a DP policy, or what tables a DP policy protects, an administrator can use the following:

SELECT * FROM data_privacy.tables_and_views where
policy_id=<...>

To determine privacy spent by each query, an administrator or an analyst can see the amounts of privacy spent by each query surface one or more of the following in an ACCOUNT_USAGE view: budget usage appears in query_history; budget usage appears in access_history (e.g., includes information about which policies and objects are accessed;); or budget usage per query appears in a new view privacy_history. The schema of the privacy_history view can comprise one or more of the following: Query ID—the query; Policy ID—the policy that was used; Budget ID—the budget within the policy that is used, and Budget used—the epsilon usage for the query.

With respect to interactivity with various features, differential privacy (DP) features of some embodiments can interact with, for example, data sharing, replication, business continuity & disaster recovery (BCDR), LAF, and cloning. For example, for data sharing, if a shared secure view or table has a differential privacy (DP) policy assigned to it, a data consumer can query via a privacy engine of a differentially private data system and the DP policy is enforced.

For replication, if a differential privacy (DP) policy is assigned to a table in primary, the DP policy can be replicated in secondary (otherwise, a refresh will fail). 2) If the DP policy has a budget adjustment (BudgetAdjustmentDPO) associated with it, it can also be replicated to secondary. No budget consumption record (BudgetConsumptionDPO) for the policy will be replicated in the secondary. In secondary, an administrator may be prevented from updating a budget adjustment for a DP policy that is replicated; rather, the budget adjustment is read-only in secondary and is synced with primary. For each query on a replicated table in secondary, budget consumption can be updated similarly as the queries in the primary. A budget specification can be scoped to a single account and may not be shared across multiple accounts; accordingly, a privacy budget in primary and secondary may not be shared.

For BCDR, if an analyst can access both the primary and secondary accounts and is able to query (e.g., differentially private query) a differential privacy (DP)-protected table, the analyst will have a double budget. When a secondary account becomes primary for a fail-over scenario, an analyst can run a query on the new primary. In general, analysts can get N* the privacy budget specified by the admin, for the number N of secondaries that the analyst can query from. For an embodiment that supports a function IS_PRIMARY, DP privacy policies can be set up in the BCDR use-case like as follows.

CREATE PRIVACY POLICY primary_policy AS ( ) RETURNS
privacy_budget −> CASE WHEN
IS_PRIMARY(CURRENT_DATABASE( )) AND
CURRENT_ROLE( )=′ROLE′ THEN
primary_budget(‘BUDGET1’)
END;

Differential privacy (DP) policies can be replicated for a table that is shared along with a budget adjustment record. For example, a data provider can allow only a specific account of an organization to perform a query with a default privacy budget. An administrator may want to do this on an assumption that accounts within an organization will collude. The administrator can, for instance, create the following DP policy to limit an account of an organization.

CREATE PRIVACY POLICY single_account_policy AS ( )
RETURNS privacy_budget −>
CASE WHEN CURRENT_ORGANIZATION_NAME(′ORG1′) AND
CURRENT_ACCOUNT(‘ACCT’) THEN
privacy_budget(‘BUDGET1’)
END;

As another example, a data provider can allow specific accounts of an organization to perform a query with a privacy budget where each account will have separate allocation of that same privacy budget amount. Accordingly, ACCT1 in LAF1 can have an instance of BUDGET1 and ACCT2 in LAF2 can have another instance of BUDGET1.

CREATE PRIVACY POLICY multiple_accounts_policy AS
( ) RETURNS privacy_budget −>
CASE WHEN CURRENT_ORGANIZATION_NAME(′ORG1′) AND
CURRENT_ACCOUNT( ) IN (’ACCT1’,
‘ACCT2’) THEN privacy_budget(CURRENT_ACCOUNT( ) ||
‘BUDGET1’)
END;

If in an alternative embodiment, a privacy budget adjustment write capability in secondary (instead of replicating privacy budget adjustment records from primary) can enable an administrator to manage the budget for individual deployments so that they can control more.

Regarding cloning, cloning a differential privacy (DP) policy may occur as a result (e.g., side effect) of an entity being cloned (e.g., table, schema or database) that contains the DP policy, and it does not happen if the entity being cloned (table, schema or database) does not contain the policy. This is consistent with other policies. The following TABLE 9 describes the effects of cloning in the various cases.

TABLE 9

| | Is Privacy | |
|---|---|---|
| | Policy | Is Privacy |
| | contained in | Policy |
| Entity cloned | the entity? | Cloned? |
| TABLE | No | No |
| SCHEMA | No | No |
| SCHEMA | Yes | Yes |
| DATABASE | No | No |
| DATABASE | Yes | Yes |

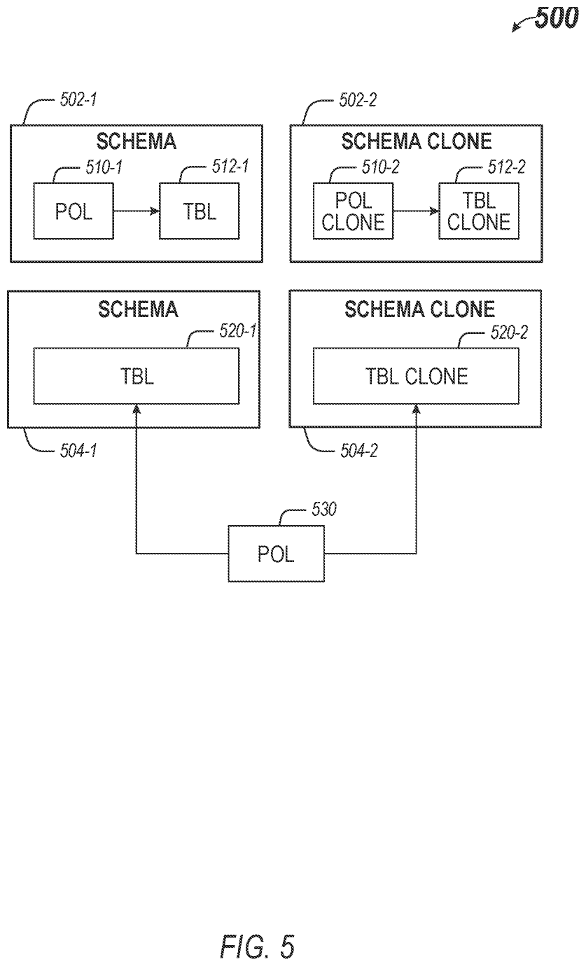

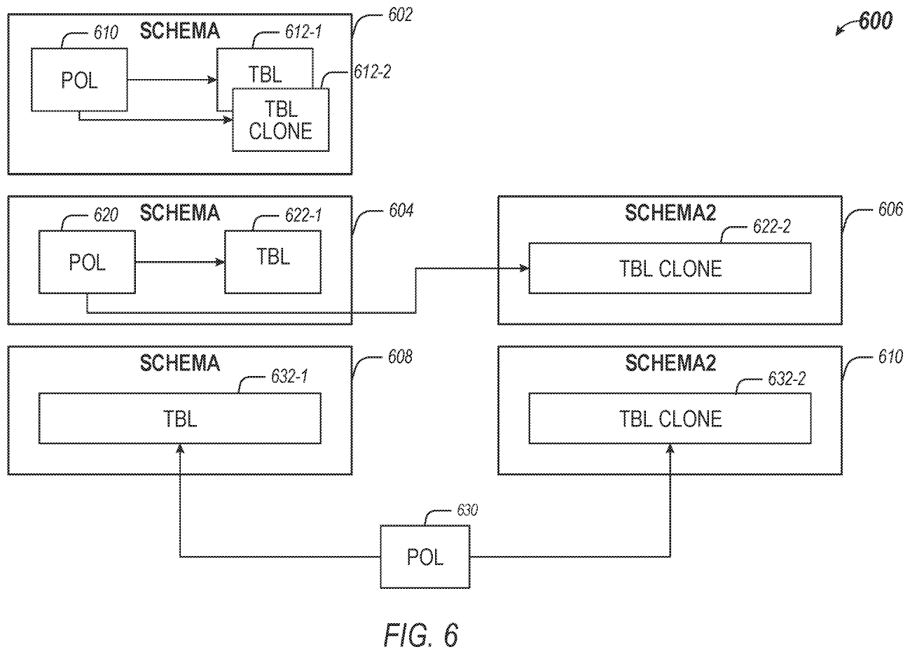

More regarding cloning is described with respect to FIGS. 5 and 6.

With respect to metadata of a given differential privacy (DP) policy P, the metadata can comprise the following: the data policy object (DPO) associated with the policy P; metadata of the BudgetAdjustmentsDPOs associated to the non-zero budgets to which the policy body has evaluated to (up to the moment of the policy drop); and metadata of the BudgetConsumptionDPOs' associated to the non-zero budgets to which the policy body has evaluated to (up to the moment of the policy drop). For some embodiments, BudgetAdjustmentsDPO metadata and BudgetConsumptionsDPO resides in different shards, with the former residing in the shard where the account of a data provider is, and the latter in the shard(s) where the accounts of a data consumer (e.g., the analysts) is. A DROP command can drop the DPO associated with the policy P. When cleaning up metadata (e.g., for a dropped policy P), to determine whether a budget consumption DPO can be deleted, a differentially private data system can check on a main shard (where the policy associated with the DPO resides) if the policy has been deleted/dropped. If yes, the differentially private data system can delete the DPO otherwise it doesn't. With respect to Budget AdjustmentDPOs and BudgetResetDPOs, the metadata cleaner can ensure that the deletion of the adjustment and refund DPOs occur when the retention time of the DP policy P has passed. It also makes sure that the adjustment DPOs are deleted even if a parent of the DP policy P is dropped. In this second case the deletion can still happen when the retention time of the DP policy P has passed.

Regarding a budget window of a privacy budget, the budget window may not be a rolling window, as the privacy spend and adjustment history is not preserved in a DPO. For some embodiments, each budget window is non-overlapping and starts and ends at a deterministic time. For example, if the budget window is defined to be “24 hour reset”, then the budget can reset at the same time each day (e.g., at midnight). Available reset frequencies for a budget window can include, without limitation, DAILY, WEEKLY, MONTHLY, and YEARLY.

In terms of budget adjustments, a privacy budget can be modified by: adjusting the budget limit; or applying a budget refund. To facilitate this, some embodiments are specific and consistent on how one or more DPOs are updated (e.g., depending on which modifications occur and in what order). An example of this is illustrated below in TABLE 10.

TABLE 10

| Actions | Resulting DPO |
|---|---|
| Refund 1.0 at t1 | { |
| | FIELD_LAST_MODIFIED = t1 |
| | FIELD_ADJUSTMENT_EPSILON_LIMIT |
| | = null FIELD_ADJUSTMENT_DELTA |
| | = null FIELD_ADJUSTMENT_WINDOW |
| | = null |
| | FIELD_REFUND_EPSILON_TIMESTAMP |
| | = t1 FIELD_REFUND_EPSILON = |
| | 1.0 |
| | } |
| SetBudget at t1 | { |
| | FIELD_LAST_MODIFIED = t1 |
| | FIELD_ADJUSTMENT_EPSILON_LIMIT = 1.0 |
| | FIELD_ADJUSTMENT_DELTA = 1e−5 |
| | FIELD_ADJUSTMENT_WINDOW = {...} |
| | FIELD_REFUND_EPSILON_TIMESTAMP = null |
| | FIELD_REFUND_EPSILON = null |
| | } |
| Refund at t1, then | { |
| set budget at t2 | FIELD_LAST_MODIFIED = t2 |
| | FIELD_ADJUSTMENT_EPSILON_LIMIT = 1.0 |
| | FIELD_ADJUSTMENT_DELTA = 1e−5 |
| | FIELD_ADJUSTMENT_WINDOW = {...} |
| | FIELD_REFUND_EPSILON_TIMESTAMP = t1 |
| | FIELD_REFUND_EPSILON = 1.0 |
| | } |
| Set budget at t1, | { |
| then refund at t2 | FIELD_LAST_MODIFIED = t2 |
| | FIELD_ADJUSTMENT_EPSILON_LIMIT = 1.0 |
| | FIELD_ADJUSTMENT_DELTA = 1e−5 |
| | FIELD_ADJUSTMENT_WINDOW = {...} |
| | FIELD_REFUND_EPSILON_TIMESTAMP = t2 |
| | FIELD_REFUND_EPSILON = 1.0 |
| | } |

Regarding privacy spend, some embodiments maintain a ledger separate from the aggregated privacy spend, which can optimize for performance of the system. The aggregated spend can be updated quickly without analyzing the full privacy history, and the ledger can be append-only and accessed much less frequently than the aggregated spend. An example of data stored in the ledger is provided below in TABLE 11.

TABLE 11

| NAME | TYPE | DESCRIPTION |
|---|---|---|
| (child) | <QueryID | A reference to the child query the privacy |
| Query id | type> | engine needs to associate with this data. |
| timestamp | Timestamp | Query execution time so we can filter out |
| | | queries based on the budget window. This |
| | | can be left out if the Query id is sufficient |
| | | to join to the query timestamp. |
| Budget | <BudgetStoreID | A query may interact with multiple tables |
| store id | type> | and entities. For each budget store the |
| | | query interacts with, we record a reference |
| | | to that budget store. |
| Sensitivity | FLOAT >= 1 | A query may duplicate entities so we |
| multiplier | | record the maximum multiplier from the |
| | | query |
| Noise type | VARIANT | An object that contains the type (Laplace, |
| | | Gaussian, etc.) and scale of the noise. For |
| | | example: Laplace(1.0) would represent |
| | | Laplace noise with scale 1.0. |

An example of data stored in a ledger for aggregated privacy spend is provided below in TABLE 12.

TABLE 12

| NAME | TYPE | DESCRIPTION |
|---|---|---|
| Budget store id | <BudgetStoreID | The budget store id. Since this data |
| | type> | will likely be stored in the budget |
| | | store, this doesn't need to be included |
| | | explicitly. If the ledger is stored in |
| | | FDB, this is required. |
| Budget | <BudgetIDType> | The budget store contains multiple |
| | | budgets so this is the identifier for a |
| | | specific budget. For instance, this |
| | | could reference a particular user's |
| | | budget. |
| RDPEpsilonSpendTotal | ARRAY of FLOAT | The total RDP spend for all queries |
| | | issued against the budget store. The |
| | | array length is fixed and contains <100 |
| | | values. The exact number can |
| | | depend on the embodiment is an |
| | | implementation detail. For example, |
| | | some embodiments can use ~30 |
| | | values. |
| EpsilonRebateTotal | FLOAT >= 0 | The total epsilon refund for the |
| | | budget store. Note: for rolling |
| | | windows, this cannot exceed the |
| | | budget. |

A privacy engine of a differentially private data system can two methods to interact with the privacy budget tracking: checkOutOfBudget and chargeBudget. The checkOutOfBudget method can check if there is sufficient privacy budget remaining to charge aNoiseType to a table budget. The privacy engine can stop early and error if there is not enough privacy budget to run a query (e.g., differentially private query).

boolean checkOutOfBudget(
Map<TableId, SensitivityMultiplier>
tablesAndSensitivityMultipliers, NoiseType
noiseType);
// Alternative: Return a list of tables that don't
have enough budget
List<TableId> checkOutOfBudget(
Map<TableId, SensitivityMultiplier>
tablesAndSensitivityMultipliers, NoiseType
noiseType);

The chargeBudget method can charge a privacy budget associated with the NoiseType and sensitivity multipliers, and record the usage in a consumption DPO for each budget the query accesses. If there is not enough privacy budget to run the query, the method can error and the privacy engine will not return the noisy query result (e.g., differentially private query result).

// Returns the privacy exposure on each table
that has budget charged. Map<TableId, Double>
chargeBudget(
Map<TableId, SensitivityMultiplier>
tablesAndSensitivityMultipliers, NoiseType
noiseType);

According to some embodiments, an analyst can submit a differential privacy (DP) query through an API, such as a Python API. Through the API, a user (e.g., analyst) can issue private queries (e.g., DP queries) on a DP policy-protected query. The following provides an example workflow for running queries through the API. (1) A user writes a differentially private query and then submits the differentially private query using the API. (2) The differentially private query is parsed by the API and transformed into its corresponding SQL query. (3) The SQL query is sent for execution to a differentially private data system. During the execution, at the end of a name resolution process, the data system checks whether the SQL query involves any entities (e.g., tables/views) that have a privacy budget associated with them (e.g., indicated that they are DP protected). If there are entities (e.g., tables/views) that have a privacy budget associated with them, an error is thrown (e.g., NOT_AUTHORIZED_ON_PRIVACY_PROTECTED_TABLE). (4) The API parses the error (e.g., NOT_AUTHORIZED_ON_PRIVACY_PROTECTED_TABLE) and reissues the SQL query using a stored procedure through a privacy engine of the differentially private data system. During this stage (e.g., issuing SQL queries through the stored procedure), a new privilege can be enabled (e.g., ALLOWPRIVACYENGINEACTION), and all SQL queries involving DP protected entities (e.g., tables/views) that are run through the privacy engine have the new privilege enabled. For some embodiments, a select query on a DP protected table (with a privacy budget) should be valid if run with the privacy engine role active, and that role can be activated only through the stored procedure.

The following TABLE 13 provides an example of how SQL queries are executed on behalf of an analyst in conjunction with a privacy engine privilege (e.g., ALLOWPRIVACYENGINEACTION).

TABLE 13

| | | Policy | ALLOWPRI- | |
|---|---|---|---|---|
| Case | | evaluation | VACYEN- | Result of SQL |
| no | Who | result | GINEACTION | query |
| 1 | Anyone | No Privacy Policy | False | The SQL query |
| | Except | Attached | | is run as usual |
| | Privacy | | | |
| | Engine | | | |
| 2 | Anyone | Privacy Policy | False | The SQL query |
| | Except | Attached but | | is blocked and |
| | Privacy | evaluates to | | an error is |
| | Engine | NULL | | thrown |
| 3 | Anyone | Privacy Policy | False | The SQL query |
| | Except | Attached and | | is run as usual |
| | Privacy | evaluates to | | |
| | Engine | no_privacy_policy( ) | | |
| 4 | Anyone | Privacy Policy | False | The SQL query |
| | Except | Attached and | | is blocked |
| | Privacy | evaluates to | | |
| | Engine | privacy_budget | | |
| 5 | Privacy | No Privacy Policy | True | The SQL query |
| | Engine | Attached | | is blocked |
| 6 | Privacy | Privacy Policy | True | The SQL query |
| | Engine | Attached but | | is blocked and |
| | | evaluates to | | an error is |
| | | NULL | | thrown |
| 7 | Privacy | Privacy Policy | True | The SQL query |
| | Engine | Attached and | | is blocked |
| | | evaluates to | | |
| | | no_privacy_policy( ) | | |
| 8 | Privacy | Privacy Policy | True | The SQL query |
| | Engine | Attached and | | is run and the |
| | | evaluates to | | privacy budget |
| | | privacy_budget | | DPOs are |
| | | | | updated |

In order to decide if a query came from a privacy engine or not, a differentially private data system can consult a privilege that is granted when the privacy engine is triggered (e.g., ALLOWPRIVACYENGINE). The following provides four possible combinations for a query Q: SELECT AVG (COL_1) FROM T given the fact that the table may have or may not have a privacy policy attached to it, and the query may have come from the privacy engine with the ALLOWPRIVACYENGINE=TRUE or may have not come from the privacy engine which means ALLOWPRIVACYENGINE=FALSE.
PrivacyPolicy IS attached to table T and evaluates to an actual PrivacyBudget && ALLOWPRIVACYENGINE=FALSE=>Privacy policy is active but privacy engine not authorized, so the differentially private data system throw an error PRIVACY_ENGINE_NOT_AUTHORIZED
PrivacyPolicy IS attached to table T and evaluates to an actual PrivacyPolicy && ALLOWPRIVACYENGINE=TRUE=>Query should be run as a privacy preserving query through the privacy engine
PrivacyPolicy IS NOT attached to table T and/or evaluates to an actual no_privacy_policyf( ) && ALLOWPRIVACYENGINE=FALSE=>Query should be run as a non-private query through a traditional (non-DP) query path.
PrivacyPolicy IS NOT attached to table T and/or evaluates to an actual no_privacy_policy( ) && ALLOWPRIVACYENGINE=TRUE=>Privacy engine is active but no privacy policies detected, so the differentially private data system throws an error INVALID ACTIVATION OF PRIVACY ENGINE.

To enforce those restrictions, a differentially private data system can use an objectsWithPrivacyBudget mark to identify an object with a privacy budget, and can check whether the ALLOWPRIVACYENGINE role is granted and based on that the differentially private data system can perform the following checks.

// while evaluating each of the nodes of the SQL
parse tree if (privacy policy evaluates to an
actual privacy budget) {
// check for the Privilege Grant
if (the ALLOWPRIVACYENGINEACTION == FALSE) {
throw an error(PRIVACY_ENGINE_NOT_AUTHORIZED)
}
objectsWithPrivacyBudget.add(currentObjRef)
}
// after the evaluation for Privacy Policy is done
for the entire SQL tree - right before we return
if (we haven't seen an actual privacy policy that
evaluates to a privacy budget
- meaning the objectsWithPrivacyBudget.isEmpty( ) )
{
// check for the privilege grant
if (the ALLOWPRIVACYENGINEACTION == TRUE) {
throw an
error(INVALID_ACTIVATION_OF_PRIVACY_ENGINE)
}
}

Alternatively, a general service and a privacy engine of a differentially private data system can perform two different checks, enforced at two different times. (1) During the evaluation of a differential privacy (DP) policy, if the differentially private data system can encounter a table with a DP policy attached that evaluates to an actual privacy budget, the general service can check the status of authorization. (2) In the privacy engine, if a query is received that involves only public tables, the privacy engine throw an error, the privacy engine calls a system function in the general service to check the privacy budgets of the tables involved, and if none of the tables have a privacy budget associated with them, the general service throws an error.

Turning now to the user experience of an analyst, various embodiments can implement one or more of the following features: implicit disambiguation of differential privacy (DP) queries; user-defined column bounds; differential privacy (DP) joins with implicit K-bounds; and randomization intervals on request. An example of a workflow by an analyst can comprise the following API calls:

import differential_privacy as dp #
separate module in PrPr import
differential_privacy.functions as F
from
differential_privacy.functions
import col session =
dp.Session( )
dpdf_patients = session.table(‘patients')
dpdf_claims =
session.table(‘prescription_claims_aggregated’)
dpdf_joined = dpdf_patients.join(dpdf_claims,
on=“patient_id”, rsuffix=“_”) dpdf_cohort =
dpdf_joined.where(col(“insurance_type”) ==
“commercial” &
col(“num_claims_drug_A_”) > 1)
dpdf_cohort.group_by( ).agg(F.sum(“num_claims_drug_{—}
B_”).alias(“sum_B”),
F.lower_bound(“sum_B”),
F.upper_bound(“sum_B”),
F.confidence_level(“sum_B”)).collect
( )

With respect to implicit disambiguation of differential privacy (DP) queries, an analyst does not need to explicitly specify that they are running a differentially private query (e.g., analyst does not need to specify that a query submitted through an API as a differentially private query). According to some embodiments, DP queries distinguish between transformations and computations. Transformations are run non-privately (i.e., without noise), and their results are not provided to (and cannot be inspected by) an analyst submitting a differentially private query. Computations are privately run and their results can be provided to (e.g., materialized/inspected by) the analyst since noise has been included. To generate and return a differentially private query result to an analyst, a differentially private query from an analysis has a computation, where computation comprises an aggregation. While not all aggregates are computations, the key area of ambiguity is group-by & agg. This can either be a computation (e.g., private aggregation) or a transformation (e.g., exact aggregation with another private computation downstream). For instance, consider the following two example queries: 1. How many ZIP codes contain at least 10 patients?; and 2. for each ZIP code, how many patients live in it?. The first query is a non-private group-by ZIP transformation, followed by a filter and a private count computation, while the second query is a private group-by+agg transformation—each zip code will have a private count. These example queries are not interchangeable (e.g., if the analyst ran the second query and filtered on the result to answer the first query, the results would be noisier than if they had run the first query, potentially too noisy). However, running the second query is more flexible in the sense that data consumers can take those results and choose whatever downstream queries they want on it. Despite this flexibility, various embodiments can insert the privacy at the very last step before results are returned for optimal operation. For various embodiments, an analyst can write queries as they normally would (e.g., without using special syntax to express what is a transformation vs. a computation), and then the query will work for DP. According to some embodiments, a differentially private data system can disambiguate a query from an analyst using the following logic: 1. a differentially private query must have one aggregate computation before a show or materialization call (e.g., such as .collect( ) or .write( )) in order to be a valid differentially private query, otherwise, an error is thrown; 2. when more than one aggregate is called (e.g., group_by( ).agg( ).agg( )), the differentially private data system will assume that the aggregate closest to the materialization call is a private computation. An analyst who wants to do additional downstream queries, must either: A. take those results and manually put them into the differentially private data system (which may be less than optimal); or B. extend/rewrite the query to answer what the ultimate question is and re-run the query.

The following TABLE 14 describes options for implementing disambiguation of DP queries with respect to API calls.

TABLE 14

| Option description | Example | Pros |
|---|---|---|
| 1. Implicit | use a heuristic e.g. | Most of the |
| disambiguation - | the PE tries to run | current |
| use a | the outermost | Snowpark |
| rule/heuristic to | operation as a | DataFrame API |
| decide which | private | syntax would |
| computations are | computation; the | stay the same, |
| run privately and | disambiguation | but now it |
| which are just | would be done once | would be used |
| data | the analyst calls the | in a |
| transformations | collect( ), .show( ), | new/different |
| | .write( ) | way under the |
| | given the following | Snowpark- |
| | SQL query | Private |
| | SELECT MEAN(c) | DataFrame |
| | FROM (SELECT | API. |
| | g, COUNT(*) AS c | Customers |
| | FROM t GROUP | don't have to |
| | BY g); an analyst | rewrite existing |
| | can mean one or | code for it to |
| | two: | work with a |
| | 1. compute the exact count | DP-protected |
| | of each group and then | object |
| | compute the private mean | |
| | df.group_by (col(“g”)).agg((col(“*”), | |
| | “count”).as(“c”)).agg(col(“c”), | |
| | “mean”).collect( ) | |
| | 2. compute the private | |
| | count of each group and | |
| | then compute the exact | |
| | mean | |
| | # materialize the | |
| | result for private | |
| | counts, and use | |
| | methods outside of | |
| | the DP DataFrame | |
| | API to compute the | |
| | exact mean over | |
| | private counts | |
| | import numpy as np | |
| | >>> dp_count = | |
| | df.group_by(col(“g“)).agg((col(“*”), | |
| | “count”).as(“c”)).collect( )[0] | |
| | >>> | |
| | np.mean(df_pri_count[“c”]) | |
| | If the outermost | |
| | operations can not | |
| | be run as a | |
| | private | |
| | computation we | |
| | fail | |
| | >>> | |
| | df.group_by(col(“g“)).agg((col(“*”), | |
| | “count”).as(“c”)).agg(col(“c”), | |
| | “sum_distinct”).collect( ) Error: sum | |
| | distinct is not a | |
| | private aggregation | |
| 2. Explicit | The analyst can signal | There is a clear |
| disambiguation - | that a private | delimitation |
| introduce a new | computation is | between what a |
| key word/suffix | supposed to happen | private |
| for computations | by using a method | computation is |
| that are meant to | under a separate | and what a data |
| be run privately | module e.g. dp_agg | transformation is. |
| | >>> | There are clear |
| | df.dp_agg(sum(col(“Salary”)), | expectations on |
| | min(col(“Salary”))).collect( ) | which results can |
| | >>> | be inspected and |
| | df.agg(sum(col(“Salary”)), | which can not |
| | min(col(“Salary”))).collect( ) Error: | due to the |
| | agg is not a | presence/absence |
| | private computation | of collect( ) |
| | # compute the | methods |
| | exact average | The private |
| | salary for each | capabilities of |
| | zipcode and | the PE can be |
| | then compute a | seen at a glance |
| | private mean of | since they |
| | that | would be under |
| | >>> | a different |
| | df.group_by(col(“zipcode”)).agg((col(“Salary”), | module/have |
| | “mean”)}.dp_agg(col(“MEAN(Salary)”), | some keyword |
| | “sum”).collect( ) | that makes them |
| | | distinct/easy to |
| | | group together. |
| | | No unexpected |
| | | new use cases |
| | | for existing |
| | | methods/ |
| | | functionalities |
| | | in the DataFrame |
| | | API. |
| 3. Add a | >>> | The Private |
| private = True | df.agg((col(“Salary“), “sum”), | DataFrame API |
| optional parameter | (col(“age”), “mean”), | looks more like |
| to the .agg | private=True).collect( ) | the current |
| method. | >>> | Snowpark |
| | df.agg((col(“Salary“), “sum”), | DataFrame |
| | (col(“age”), “std”), | API. |
| | private=True).collect( ) | |
| | Error: std is | |
| | not a supported | |
| | private computation | |
| 4. Add a prefix | Add a prefix to | Private |
| dp_or private_to | signal a new private | methods are |
| those methods that | module under | grouped |
| are meant to run as | which private | together under |
| private | aggregates reside | the same sub- |
| computations. | >>> | module |
| | df.dp_agg((col(“Salary”), “sum”), | Discovery of |
| | (col(“age”), “mean”)).collect( ) | those private |
| | >>> | methods is |
| | df.dp_agg((col(“Salary”), | easier for an |
| | ”sum”), (col(“age”), | analyst. Only |
| | “std”)).collect( ) | those private |
| | Error: std is not a | methods would |
| | supported private | have a .collect( ) |
| | computation | or .show( ) |
| | | method. |
| 5. Add a private | >>> | The DataFrame |
| keyword optional | df.agg((col(“Salary”), “sum”, | API may look |
| parameter to the | private = True), (col(“age”), | outwardly |
| methods that are | “mean”, | pretty much the |
| meant to run as | private = True)).collect( ) | same, the |
| private | >>> | private |
| computations. | df.agg((col(“Salary”), “sum”, | keyword is an |
| | private = True), (col(“age”), | optional one |
| | “min”, | |
| | private = False)).collect( ) | |
| | Error: cannot run a | |
| | non-private | |
| | computation - | |
| | misuse of collect | |

Regarding user-defined column bounds, column bounds can be use with one or more differential privacy (DP) queries to bound estimations with DP, and can be set by an administrator (e.g., analyst can provide bounds as part of their query if they are not satisfied with admin-set bounds, or if admin has not set them). The scale of the noise added in a differentially private query is usually sufficient enough to hide the contribution of any specific entity that might have contributed to a private aggregate. Accordingly, various embodiments bound the max contribution of any specific entity (otherwise the magnitude of the noise would be infinite and the differentially private query result would be useless).

Generally, it is possible to determine the exact bounds or domain from the data, but this approach presents a privacy risk. For example, analysts can construct queries to learn what bounds were used to calculate the amount of noise, and if the bounds are based on specific values in the data, analysts will have learned sensitive information about an individual. For instance, if the upper bound for patient age is determined from the data, the analyst can write queries to discover the bound, and they can then know whether or not the dataset includes the oldest living person, a violation of DP. This consideration also applies to string columns. Without well-defined string domains, a system would not know what strings are valid and can be presented in the result. For example, a group-by+aggregate count computation on a string field can be thought of roughly as “loop over the valid values for this string field and do a filter+count.” In DP, the “valid values” can be sensitive (e.g., how does the system know what a “valid value” is for a column like patient name?). Even if the column has a publicly known domain like zip code or drug name, using the exact domain determined from the data can allow an attacker to learn about people who live in very sparsely populated zip codes or who are one of very few people taking a rare disease drug.

In view of this, various embodiments can determine one or more bounds privately, automatically, or both. An example of this can be using a differentially privacy (DP) algorithm to estimate the 5th and 95th percentiles of numerical fields to use as bounds. Given that this may not produce good estimates, and DP string domains cannot be handled this way, for some embodiments, an administrator (e.g., an administrator will likely have a better sense of what the column bounds should be based on knowledge of the data) or an analyst can provide one or more bounds. Additionally, one or more algorithms for DP estimates of bounds can be used as telemetry to gather information on how well bounds (e.g., defined by an administrator or an analyst) are performing on real data. A numerical columns can have one or more bounds (e.g., provided either by the admin or the analyst) in order for a query to be run on them, and a string column can have a domain (e.g., provided either by the admin or the analyst) in order for the analyst to be able to do a private group-by+agg on them.

As an example, an administrator can provide bounds as a new inline constraint, similar to a check constraint, as follows:

CREATE TABLE <table_name>
<col1_name> <col1_type> [ NOT NULL ] {
inlinePrivacyBounds | ... } [ , <col2_name>
<col2_type> [ NOT NULL ] { inlinePrivacyBounds |
... } ] [ , ... ])
inlinePrivacyBounds ::=
[ CONSTRAINT <constraint_name> ]
[ [ CHECK PRIVACY BOUNDS (<col1_name> BETWEEN <lo>
AND <hi>) ] | [ CHECK PRIVACY BOUNDS (<col1_name> IN
(‘val1’, ‘val2’, ...)] |
[ REFERENCES PRIVACY BOUNDS
<other_table_name>(<col_name>)] ])

In this example, only one privacy bound can exist on each column, and <other_table_name>(<col>) must be a valid column. If the administrator has not provided bounds, or if an analyst wants to set their own for utility reasons or to be able to do a group-by+agg on a string field, the analyst can provide their own bounds. An analyst can bound numerical and string columns with filters, and specifically for string columns they can also join to a non-DP protected table to use as the domain. The following is an example of this:

dpdf_patients = session.table(“patients”)
dpdf_patients = dpdf_patients.where((col(“age”) >=
0) & (col(“age”) <= 100))
.where(col(“insurance_type”).isin(“Medicaid”,
“Medicare”, “Commercial”))
df_ca_zipcodes =
session.table(“zipcodes”).where(col(“State”) ==
“CA”)
dpdf_patients.join(df_ca_zipcodes.drop_duplicates(“
zipcode”), on=“zipcode”, join_type=“right”) I am
running a few minutes late; my previous meeting is
running over.
.group_by(“zipcode”,
“insurance_type”).agg(F.mean(“age”)).collect( )

In this example, the analyst is bounding the age column so they can run queries on it, the analyst is defining a domain for insurance_type with a filter, and the analyst is defining a domain for zipcode by joining with a reference table.

The following TABLE 15 describes options for implementing disambiguation of DP queries.

TABLE 15

| Option | Pros |
|---|---|
| 1. New Privacy | These bounds only affect queries |
| Bounds constraint | on DP-protected tables/views |
| | We can design the syntax to be |
| | exactly how we want admins to |
| | define bounds |
| 2. Check Constraint | Standard SQL functionality; will be |
| for numeric columns | easier to integrate with third-party |
| | tools |
| 3. Foreign Key | Fully supported, standard SQL |
| constraint for strings | functionality; will be easier to |
| | integrate with third-party tools |
| 4. Exact bounds are | No new functionality needed |
| used, but admins use a | |
| view to define | |
| numeric column | |
| bounds | |

For differential privacy (DP) joins with implicit K-bounds, some embodiments permit 1-1 joins, which can be enforced by checking that an administrator has marked join keys as unique, and that an analyst has not transformed the data in a way that may violate uniqueness. Some embodiments can issue an error when joins are attempted between DP-protected objects that are not 1-1; in doing so, analysts can avoid needing to provide bounds on the contribution of join keys to the join (k-bounds). Joins can be different from other transformations (e.g., WHERE, UNION) due to the amplification of privacy risks that can happen if they are not handled properly for DP. For transformations like WHERE and UNION, including/excluding one record/entity in the input has a bounded constant effect on the output. On the other hand, for joins this effect can be unbounded: a single record in either table could match an unbounded number of records in the other table, and this means that a single change to either component table affects an unbounded number of rows in the output. Accordingly, similar to column bounds, some embodiments can bound contributions from component tables in a join in order for a differentially private query to determine a useful amount of noise to add. This bound can be referred to as a k-bound. A K-bound can truncate a contribution from component tables to the join.

The following TABLE 16 describes one or more options for implementing K-bounds.

TABLE 16

| Option | Pros |
|---|---|
| 1. Limit to 1-1 joins (i.e., | Analyst doesn't need to |
| assume k = 1). Join keys must | think about k-bounds |
| either have been marked | |
| unique by the admin and/or | |
| be transformed to be unique | |
| by the analyst | |
| 2. DP k-bounds: Compute | No additional work for |
| k-bounds privately from the | the admin or the |
| data | analyst |
| 3. Have the analyst to set | Analysts have flexibility |
| their own k-bounds to be able | to tune k-bounds to get |
| to join | good utility |
| 4. Have the administrator to | Analyst doesn't need to |
| set k-bounds | think about k-bounds |

Some embodiments can support a row-level DP limitation with respect to joins, and an administrator would need to perform extra steps to implement use cases that don't satisfy the row-level DP assumption by default. For example, consider an ad reach use case in which an analyst would like to know how many users saw a certain ad campaign. Where the impressions table is to be transactional (e.g., the user sees one impression from one campaign in each row), the administrator can pre-aggregate the data before protecting it with DP and sharing with the analysts. For example:

CREATE TABLE impr_by_user (user_id UNIQUE,
num_campaign_1, num_campaign_2) AS SELECT user_id,
COUNT_IF(campaign_id = ‘campaign_1’),
COUNT_IF(campaign_id = ‘campaign_2’) FROM
impressions GROUP BY user_id

Some embodiments can support entity-level differentially privacy (DP), which can avoid 1-1 join limitation and can obviate the need for an administrator to pre-aggregate data. Analysts can have access to the transactional tables directly and can choose what aggregates they want to do themselves, rather than being limited to what the admin has pre-computed.

In order to enforce that joins are 1-1, a differentially private data system can check that join keys are unique. To check this, the differentially private data system can look for the following conditions for both sides of the join: 1. the administrator has specified that the join key is unique within the table or view; if the column is not actually unique, the entity-level privacy guarantee is not upheld because the join could amplify entity information; and 2. an analyst has transformed the data to be unique on the join key (e.g., using drop_duplicates(<join keys>) or group_by(<join keys>)) and there are no other transformations between this one and the join that could violate the uniqueness (e.g., UNION). The DP system will check that at least one of these is true, and then; if neither of these is true, the join will throw an error, regardless of whether the keys are unique. The differentially private data system must error even if the join key happens to be unique because if it did not, this would give the analyst side-channel information, a violation of DP. If only (1) is true, the differentially private data system can drop data in order to enforce the 1-1 join, since that is what the admin has stated as an assumption. If(2) is true, the join can be executed as usual. Checking both of these conditions enables both simple and complex cases. With respect to a simple use case, with the row-level DP limitation, an admin can share data that is unique on entity_id. An admin can explicitly indicate this assumption using the uniqueness indication. For the simple use case, in which the analyst does not do any transformations that could violate this uniqueness, they will be able to do a join as usual. For the complex use case, if an analyst needs to do transformations that could violate uniqueness of the join keys, they must ensure that the join keys are unique.

The following TABLE 17 describes one or more options for implementing checking of 1-1 joins.

TABLE 17

| Option | Pros |
|---|---|
| 1. Analyst must ensure | This pattern is a best practice that we |
| uniqueness of join keys, e.g., | want analysts to learn anyway, i.e., |
| using GROUP BY or | lower k → less noise |
| DISTINCT right before the | |
| JOIN | |
| 2. Admin add a uniqueness | No additional features needed |
| data quality check | No new overhead for the analyst |
| | Works for both tables and views |
| 3a. Admin adds enforced | No additional features needed |
| uniqueness constraints to | No new overhead for the analyst |
| expected join keys | |
| 3b. Admin adds uniqueness | No additional features needed |
| constraint to expected join | No new overhead for the analyst |
| keys, data is dropped at | |
| differentially private query | |
| runtime to enforce | |
| 4. Analyst must ensure | Extensible for the future |
| uniqueness of join keys, using | |
| a new specialized operator | |
| K_TRUNCATE, e.g., df1.trun- | |
| cate(join_key1).join(df2.trun- | |
| cate(join_key2), | |
| df1.join_key1 = | |
| df2.join_key2) | |
| 5. New operator | More flexibility for the analyst to |
| K_BOUNDED_JOIN: | address use cases with complex join |
| df1.k_bounded_join(df2, | conditions, e.g., the ad conversion |
| df1.join_key1 = | use case |
| df2.join_key2) | |
| # k = 1 by default | |

With respect to randomization intervals (e.g., upon a user request), analysts can use randomization intervals (RIs) on differential privacy (DP) aggregates in order to understand the amount of noise (e.g., noise injected into) in a DP result (e.g., “The private estimate is 49, and with 95% confidence the exact result is between [46, 52]”). The interval and level of confidence can be considered the randomization interval. Analysts can request one or more RIs explicitly using functions, or the RIs can be returned automatically in results metadata (which can then be surfaced automatically to the analyst.

Analysts need to be able to understand the amount of noise in a differentially private query result before they can trust it, and Randomization Intervals (RIs) can be used for this purpose. In addition to the private result, the randomization interval will tell the analyst, “with 95% confidence, the exact result is between [46, 52].” Analysts are able to look at the RI and decide whether the range is too wide for the result to be useful. This is also the way for analysts to get feedback on the amount of noise in the result when they are optimizing it for utility.

For some embodiments, RIs are explicitly requested as part of a differential privacy (DP) query and are returned as additional columns in the result. For instance, the following example can be executed as a differentially private query (via an API).

dpdf_cohort.group_by( ).agg(F.sum(“num_claims_drug_B
_”).alias(“sum_B”), F.lower_bound(“sum_B”),
F.upper_bound(“sum_B”),
F.confidence_level(“sum_B”)).collect( )

The result return can comprise the following TABLE 18:

TABLE 18

| | LOWER_{—} | UPPER_{—} | CONFIDENCE_{—} |
|---|---|---|---|
| | BOUND | BOUND | LEVEL |
| sum_B | (“sum_B”) | (“sum_B”) | (“sum_B”) |
| 50 | 46 | 54 | 0.95 |

The following TABLE 19 described options for implementing RI.

TABLE 19

| Option | Pros |
|---|---|
| 1. On request, in | Fits existing syntax patterns |
| results | Analyst has control over when there are |
| | additional columns, so workloads won't break |
| | unexpectedly |
| 2. Always returned, in | Analyst doesn't need to remember to write |
| results. | their query to request an RI |
| In addition to “on | Additional result metadata will not break |
| request”, 3. always | workflows |
| returned, in result | |
| metadata | |

Privacy domains (also referred to herein as differential privacy domains or column bounds) are used to execute differentially private group-bys and aggregation queries. The following will describe (1) how an administrator can manage privacy domains, and (2) how privacy domains can impact an analyst's experience. In general, enumerability is used for group-by's, and boundedness is used for aggregations like SUM and percentiles. For some embodiments, a differentially private data system implements both properties using privacy domains, which can be column metadata.

As used herein, enumerability can mean that a column's domain values must be fully enumerated. For instance, when a column is being used as a GBAV key. (e.g., ‘race’ must be enumerable for this query: SELECT . . . GROUP BY (race)). As used herein, boundedness can mean that a column's min and max value are known. For example, when a column is being aggregated (e.g., ‘age’ must be bounded for this query: SELECT SUM(age) . . . ). Though boundness and enumerability are separate, they are related concepts—boundedness can imply enumerability when the domain size is discrete and small. For instance, the type “integer [lo=0, hi=10]” is both enumerable and bounded, but the type “float [lo=0,hi=1]” is bounded, but not enumerable. Depending on the embodiment, enumerable can be applied to a Booleans, integers, dates, and factors (e.g., a concrete text-ish type), and bounded can be applied Booleans, integers, floats, dates, and datetime (all of which come with [min, max] bounds). For various embodiments, boundness and enumerability will be enforced by a per-column constraint, which can be referred to as a privacy domain. Additionally, for some embodiments, applicability of privacy domains is implemented according to one or more of the column types and the bound types described by TABLE 20.

TABLE 20

| Column Type | Bound type |
|---|---|
| Numeric, Date & timestamp | A tuple: [lo, hi] |
| | Note: PE only supports list- |
| | based domains for strings |
| String | One of: |
| | A list of string values |
| | A column reference |
| Logical | System-defined as {T, F}. |
| | Admin cannot create bounds for |
| | boolean columns. |
| Semi-structured, Geospatial, | Not yet supported |
| Binary, Time | |

With respect to commands and syntax that can be used by a user (e.g., administrator) for privacy domains, the following TABLE 21 comprises one or more examples data definition language (DDL) for a user of a differentially private data system in accordance with various embodiments described herein.

```
TABLE 21
Create privacy domain
  CREATE TABLE <table name> (
    <column_name> <column_type>
    PRIVACY DOMAIN [ # For
    numeric and date columns
      [ BETWEEN (<lo>, <hi>)] |
      # For string columns
      [ IN ( ′val1′ , ′val2′, ...)] |
      [ REFERENCES <other_table_name>(<col>)] ])
  ALTER TABLE <table_name> ADD COLUMN <column_name>
  <column_type> PRIVACY DOMAIN [constraint property]
Here, syntax is consistent with the per-column uniqueness constraint syntax.
Behavior
- No write-time enforcement. Privacy bounds are only used during query time.
Insertions to the table or bound alterations will not trigger any bound checking.
- Inferred numeric bound from enumeration. The clause “IN (1,4,10)” implies it's
bounded between [1, 10], and so such columns would be usable in an aggregation.
- Inferred enumeration from numeric bound. The clause “BETWEEN(1,3)”
implies “IN (1,2,3)”, and so such columns would also be usable as a group-by key.
Alter privacy domain
This simply overrides the existing (if any) bounds.
  ALTER TABLE <table_name>
  [ALTER|MODIFY] [COLUMN] <column_name> SET PRIVACY
  DOMAIN [domain property]
Drop privacy domain
  ALTER TABLE <table_name>
  [ALTER|MODIFY] COLUMN <column_name> UNSET PRIVACY
  DOMAIN
View privacy domains
There are two ways of viewing privacy domains:
1. DESCRIBE TABLE. We add a new column ‘privacy domain’ of type
OBJECT.
2. COLUMNS view in account_usage and information_schema.
Privacy domain object
Here is the schema of the privacy domain object:
  // One of [BETWEEN, IN, REFERENCES]
  string type;
  // Only populated if domain_type = BETWEEN value low;
  value high;
  // Only populated if domain_type = IN value[ ] values;
  // Only populated if domain_type = REFERENCES
  // The dissection of the name components follows
  REFERENTIAL_CONSTRAINTS string catalog;
  string schema; string table; string column;
Here are some example objects, presented in JSON format.
  // SQL: BETWEEN(TO_DATE(″2023-01-01″), TO_DATE(″2023-
  01-01″))
  {″domain_type″: ″BETWEEN″, ″low″: ″2023-01-01″,
  ″high″: ″2023-01-01″}
  // SQL: IN (″city1″, ″city2″)
  { ″domain_type″: ″IN″, ″values″: [″city1″, ″city2″]}
  // SQL: REFERENCES
  TEST_TABLE(TEST_DB.TEST_SCHEMA.TEST_TABLE.TEST_COL)
  {″domain_type″: ″REFERENCES″, ″database″: ″TEST_DB″,
  ″schema″: ″TEST_SCHEMA″, ″table″: ″TEST_TABLE″,
  ″column″; ″TEST_COL″}
Serialization of multi-typed values. The ‘value’ type as described above is actually
either a JSON number or string.
- SQL-to-JSON type mapping. [Input] The user defines a privacy domain in SQL
syntax, and hence can dictate the LogicalTypeEnum. [Output] The output in DESC
TABLE, on the other hand, is in an OBJECT column, with the query output being
in JSON string format. [Mapping] Thus, we discuss the mapping from
Logical_TypeEnum to JSON types.
- REAL/FIXED −> Number
- TEXT/CHAR −> String
- DATE −> String. We use the yyyy-MM-dd format. Note that JSON does not
support dates.
- TIMESTAMPs −> String. The string format follows the default used by
CURRENT_TIMESTAMP. Just like the DATE string format, this is timezone-less.
E.g. 2023-07-04 00:00:00.000000000.
- Value type dependent on column type. The output {″domain_type″: ″IN″,
″values″: [″2023-01-01″]} is ambiguous. It can correspond to both these SQL
definitions: IN(TO_DATE(″2023-01-01″)) or IN(″2023-01-01″).
Issue aggregation queries
In the example below, column_name must have a privacy domain specified.
  SELECT SUM(<column_name>) FROM <table_name>
Who provides the bounds? A bound must be provided by at least the admin or the
analyst. If the admin specifies the bound, the analyst can issue the query without
extra work. If the admin has not specified the bound, the analyst must override the
bound, or the query will be rejected.
Bound enforcement on query time. For numerics and dates, we clamp non-null
values, but discard null values. For strings, we treat them as null.
Relational-group by does not use privacy domain information at all, because there
is no noise to add. In fact, after relational-group-by sum, the resulting privacy
domain becomes unbounded.
Error behavior
- If both the admin and analyst do not specify the bound.
- If we have enumeration (e.g., IN (3,5,8)), we use the min and max value as the
bounds.
Out-of-bound values. Numeric out-of-bound values will get clamped to their
privacy domain, whereas non-numeric out-of-bound values will get transformed to
null.
Issue group-by query
In the example below, column_2 must also have a privacy domain specified. Syntax
  SELECT SUM(<column_1>) FROM <table_name> GROUP BY
  <column_2>
Bound enforcement on query time. Values that are outside of the bounds will still
be included, but be merged under a new special group.
Type check. Support can include [Booleans, dates, strings and integers].
- Can group-by on Booleans, integers, dates, and factors/strings; can group by all
column types.
Relational-group by does not use bound information at all. E.g., we allow group-
by on unbounded string columns.
Out-of-bound values. Numeric out-of-bound values will get clamped to their
privacy domain, whereas non-numeric out-of-bound values will get transformed to
null.
Error behavior
- If both the admin and analyst do not specify the bound.
- Too many groups. E.g. if you group by an int column with range [0, 1e10], then
you will get an error during query execution.
- Impossible bounds. When the domain resolves to an empty set, the privacy engine
should return an empty result as well.
Tightening privacy domains in query
During query-type, analysts can override the admin-provided bounds. The
following shows examples for GROUP-BY queries, but a data system can follow
the same syntax for overriding the bounds used for aggregation queries.
Range bounds for dates and numerics
Analysts can override the bounds for dates and numerics in multiple ways:
1. By using a WHERE clause with inequalities.
  SELECT COUNT(*) FROM <table_name> WHERE <column_name>
  <= 100 and
<column_name> >= 0 GROUP BY <column name>
Python
        # filters 0 <= a < 10 where((col(″a″) < 10) &
        (col(″a″) >= 0))
2. By using BETWEEN
Python
        # −1 <= filtered_a <= 1
        # the privacy domain for column ‘a‘ is untouched
        col(″a″).between(−1, 1).as_(″filtered_a″)
3. By using the column transformations [greatest, least]
  SELECT COUNT(*) FROM <table_name> GROUP BY
  GREATEST(LEAST(<column_name>, 100),0)
Python
        # Clamps “clamped_a” to [0, 100]
        # the privacy domain for column ‘a‘ is untouched
        F.greatest(F.least(col(″a″) , 100),
        0).as_(″clamped_a″)
        # the other way around also works
        F.least(F.greatest(col(″a″), 0),
        100).as_(″clamped_a″)
String bounds
Analysts can override bounds for string columns in multiple ways:
1. By using a WHERE clause with IN and simple literals, or equalities.
  SELECT COUNT(*) FROM <table_name> WHERE <column_name>
  IN (′a′, ′b′) GROUP BY <column_name>
  SELECT COUNT(*) FROM <table_name> WHERE <column_name>
  = ′a′ OR
  <column_name> = ′b′ GROUP BY <column_name>
Python
        # both set the domain to {″foo″, ″bar″}
        where((col(″a″) == ″foo″) | | (col(″a″) == ″bar″))
        where(col(″a″).isin([″foo″, ″bar″]))
2. By doing a public join
SELECT COUNT(*) FROM <table_name> JOIN
<public_table_name> USING (<column_name>) GROUP BY
<column_name>
Python
        df_patients = session.table(″patients″)
        df_zipcodes = session.table(″zipcodes″)
        # left semi-join, where the DP-protected relation
        is on the left df_patients.join(df_zipcodes,
        on=″zipcode″, join_type=″leftsemi″, rsuffix=″_″)
        Let me know if there is anything else I can help
        you with.
        .group by(″zipcode_″).agg(F.count(″*″)).collect( )
        # can GBAV, grouping on any column added in from
        the ′public′ table df_patients.join(df_zipcodes,
        on=″zipcode″, join_type=″leftsemi″, rsuffix=″_″)
        \
        .group by(″state″).agg(F.count(″*″)).collect( )
        # Open Q: will this work, since ‘zipcode‘ is from
        the left private table?
        df_patients.join(df_zipcodes, on=″zipcode″,
        join_type=″leftsemi″, rsuffix=″_″)
        \
        .group_by(″zipcode″).agg(F.count(″*″)).collect( )
```

With respect to access control and privacy domains, for some embodiments, a user (e.g., an analyst) needs to be whitelisted in a privacy policy and have the SELECT table privilege to run differential private (DP) queries. Regarding managing privacy domains, access control can be similar to managing other table properties: to create, alter, or drop a privacy domain, a user may need OWNERSHIP privilege on the table, and to view privacy domain info of a table using DESCRIBE TABLE and in the columns view, a user may need to have a SELECT privilege.

With respect to cross-feature interaction and privacy domains, some embodiments support one or more of cloning, replication, and object type with respect to privacy domains. For example, when a user clones a table, the bounds (e.g., privacy domains) are also cloned. This can provide consistency with other column constraints and privacy budget. With respect to replication, privacy domains can be preserved when objects are replicated. In terms of cross-object bound inheritance, some embodiments will prevent inheritance of bounds across objects. For instance, if a user creates a view on top of a table, the bounds do not transfer. If a user modifies the bounds of abase table, the downstream view's bounds will not change. In such cases, a user (e.g., administrator) would need to redefine the bound on the view even if the base table already has bounds defined. Depending on the embodiment, privacy domain can be supported with respect to tables, views, materialized views, external tables, or some combination thereof. Additionally, for some embodiments, privacy domain changes are visible in an access history.

For some embodiments, a privacy domain is stored in a data privacy object (DPO) (e.g., TableColumnDPO DPO). Privacy domain can be treated as a as a column property. The DPO can comprise one or more of the following fields. Integer field getPrivacyDomainBoundType corresponds to a bound type enumerable (e.g., BETWEEN vs IN ( . . . )). String getPrivacyDomainValues can comprise a string representation that can be used for both [RANGE, LIST] bound types. For RANGE, there can be a limit of 2 values.

According to some embodiments, during a differentially privacy (DP) query execution, a differentially private data system makes a system function call to fetch privacy domain details of the differentially private query. For example, the system function can be named SYSTEM$GET_PRIVACY_DOMAINS and can accept one or more of the following arguments. String objectName. This is the name of any table-like objects (e.g., view, table, external table, . . . ). String domain. The type for the object. (e.g., TABLE, which can cover all these table-like objects, including for example [table, view, my, external table]. String[ ] columnNames. The columns within the object to fetch domains for. This can be a comma-separated list of column identifiers, enclosed parentheses. For example, (<col1>[, <col2> . . . ]). The return value of the system function can comprise a string representation (e.g., of a JSON object), where each item corresponds to a columnName. The keys can be the column identifiers, and the value can be a PrivacyDomain object (e.g., JSON object) of the following schema:

PrivacyDomainJSON {
// Determines the type of the values.
// This is a subset of LogicalTypeEnum
value type: enum [FIXED, TEXT, DATE, (and
more, but let's start with these 3)]
// The type of the domain domain type: enum [
RANGE, // BETWEEN IN (3,5) LIST, // IN
(“a”, “b”, “c”)
// There will be more someday. E.g table
column reference
]
// Only one of these gets populated. See
domain_type. range_details: RangeDetails;
list_details: ListDetails;
}
RangeDetails { low: Value high: Value
}
ListDetails { values: Value
}
// I lied. Value isn't a class.
// It's actually just a string that can
represent any typed value. Value = String

If a privacy domain isn't set on a column, an empty PrivacyDomain object can be returned (e.g., one that just includes the column as key). With respect to obtaining privacy domain information, a user may need SELECT privilege on the table (e.g., to enable an analyst permission to get such information).

The following describes an example flow using a system function. A privacy engine can call a specific function that can issue a call with SELECT SYSTEM$GET_PRIVACY_DOMAINS (?, ?, ?) where arg1=my table, arg2=TABLE, arg3=(“Col 1”, “Col 2”). An example of a returned JSON string corresponding to 1 column with domain=IN (date1, date2, date3) is as follows.

{
“\”Col 1\“”: { “domain_type”: “LIST”, “value_type”:
“DATE”, “list_details”: {
“values”: [“1694542976”, “1694542977”,
“1694542978”]
}
}
... <one for each col>
}

Alternatively, for some embodiments, a privacy engine of the differentially private data system calls DESCRIBE TABLE (e.g., as a SQL command) on the table of interest and parses the “privacy domain” column that is returned. An example of the format of the string of “privacy domain” can be as follows: regex: (BETWEEN|IN)\(values, . . . )) (e.g., IN(‘v1’,‘v2’,‘v3’), BETWEEN(2,3)); and to figure out the type of the values, and hence which parsing logic to use, the privacy engine can use the column type.

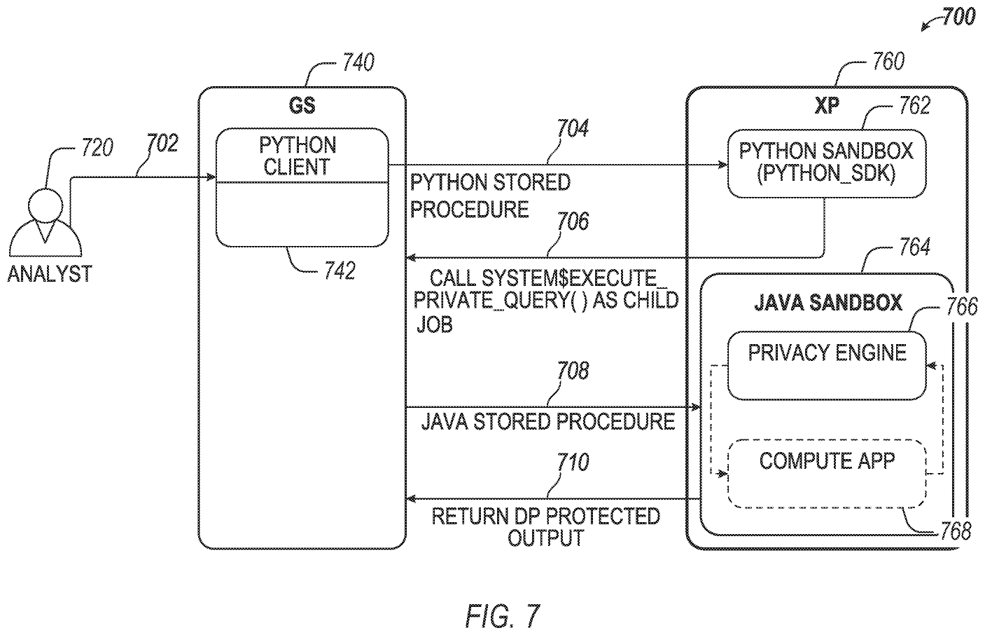

More regarding various embodiments of a database system that implements differential privacy (DP) features using one or more stored procedures are illustrated and described with respect to FIGS. 7, 8, 9, and 10.

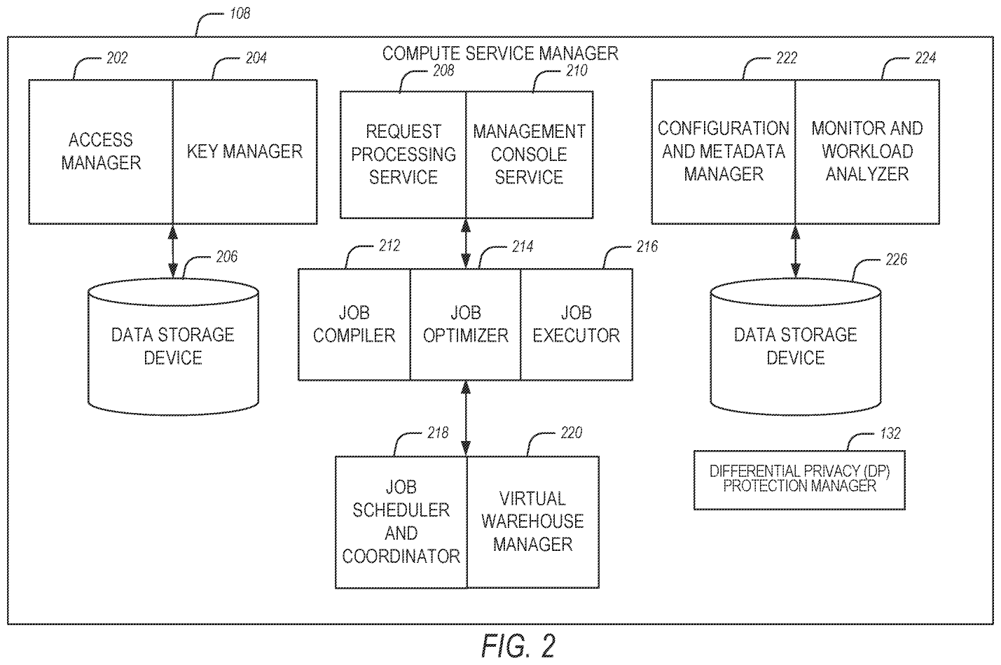

FIG. 2 is a block diagram illustrating components of the compute service manager 108, according to some embodiments. As shown in FIG. 2, the compute service manager 108 includes an access manager 202 and a key manager 204 coupled to an access metadata database 206, which is an example of the metadata database(s) 112. Access manager 202 handles authentication and authorization tasks for the systems described herein. The key manager 204 facilitates the use of remotely stored credentials to access external resources such as data resources in a remote storage device. As used herein, the remote storage devices may also be referred to as “persistent storage devices” or “shared storage devices.” For example, the key manager 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the key manager 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A.

Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

As previously mentioned, the compute service manager 108 includes the DP protection manager 132 configured to facilitate differential privacy (DP) features with respect to one or more objects (e.g., tables or views of the network-based database system 102) according to various embodiments.

FIG. 3 is a block diagram illustrating components of the execution platform 110, according to some embodiments. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues and network overhead). In some embodiments, the imbalances are addressed at the scan level using a file-stealing scheme. In particular, whenever a node process completes scanning its set of input files, it requests additional files from other nodes. If one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud storage platform 104 (e.g., from data storage device 120-1), and does not download the files from the transferring node. In this way, lagging nodes can transfer files via file stealing in a way that does not worsen the load on the lagging nodes.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

In some embodiments, table data can be divided into one or more micro-partitions, which are contiguous units of storage. As used herein, the terms “partition files” (or “partition data files”) and micro-partitions are interchangeable. In this regard, source table data can be stored as multiple partition files associated with the source table.

FIG. 4 is a simplified block diagram of an example differential privacy (DP) budget store 400 (hereafter, budget store 400) for managing one or more different privacy budgets (or privacy budgets) for one or more DP policies in a data system, according to some embodiments. According to various embodiments, a privacy budget store (or budget store) is associated with each DP policy, and each budget store comprises a set of privacy budgets (e.g., multiple privacy budgets). Each privacy budget can be labeled with a name (e.g., budget name) and comprise two data policy objects (DPOs). A budget consumption can comprise an amount of budget used by each principal (e.g., user), and a budget adjustment can comprise an administrator-driven adjustment to a budget limit. With respect to permissions, a budget adjustment can be written by an account (e.g., policy account) that the DP policy belongs to. A budget consumption can be written by the account (e.g., principal account) that runs the associated analysis. To compute the total budget consumption associated with a privacy budget, the consumption can be aggregated across all principal accounts.

As shown, the budget store 400 comprises a differential privacy budgets 402-1 named “BUDGET NAME 1,” and a differential privacy budgets 402-2 named “BUDGET NAME 2,” where the differential privacy budgets 402-1 can be referenced (e.g., by a first differential privacy policy) by the name “BUDGET NAME 1” and the differential privacy budgets 402-2 can be referenced (e.g., by the first differential privacy policy or a second different differential privacy policy) by the name “BUDGET NAME 2.” The budget store 400 can be configured to track differential privacy budget consumption and one or more refunds with respect to each differential privacy budget that the budget store 400 manages. Additionally, the budget store 400 can be configured to track each differential privacy budget consumption/refund(s) according to (e.g., with respect to) individual principals, which can represent a users or roles. As shown, the budget store 400 tracks and manages budget consumption/refund(s) 410-1 of the differential privacy budget 402-1 and does so on an individual principal basis (represented by principals 412-1), and separately tracks and manages budget consumption/refund(s) 410-2 of the differential privacy budget 402-2 and does so on an individual principal basis (represented by principals 412-2). The budget store 400 can be configured to manage differential privacy budget adjustments with respect to individual differential privacy budgets, where such an adjustment can be set by a user (e.g., administrative user). A differential privacy budget adjustment for the differential privacy budget 402-1 is represented in the budget store 400 as budget adjustment 414-1, and a differential privacy budget adjustment for the differential privacy budget 402-2 is represented in the budget store 400 as budget adjustment 414-2.

Depending on the embodiment, the budget store 400 can use various types of noise and Renyi differential privacy (RDP) curves to measure consumption of a privacy budget. The following internal mathematical details of noise and RDP curves can be summarized into a single value: the approximate-DP epsilon. Examples of noise types are listed in the TABLE 22 below, and can be coded to be numerically stable for all alpha>=1, including alpha=infinity.

TABLE 22

| Noise type | Reference |
|---|---|
| SequentialComposition | https://arxiv.org/abs/1702.07476 Proposition 1 |
| ParallelComposition | No reference exists |
| Laplace (scale = λ) | https://arxiv.org/abs/1702.07476 Proposition 6 |
| Gaussian (scale = σ) | https://arxiv.org/abs/1702.07476 Proposition 7 |
| Pure differential | https://arxiv.org/pdf/1605.02065.pdf |
| privacy (ϵ) | |
| DP | |
| | Proposition 3 |
| Exponential | https://differentialprivacy.org/exp onential- |
| Mechanism (ϵ) | mechanism-bounded-range/ |
| Exp | |
| Group privacy | |
| Convert RDP to | https://arxiv.org/abs/1702.07476 Proposition 3 |
| approximate-DP | |
| (ADP) | |

The budget store 400 can store privacy ledger details as data policy objects (DPOs), which can simplify how data sharing is handled. Additionally, budget consumption can be tracked in each account boundary, and the consumption DPO can be keyed as <consumerAccountId, providerPolicyId, budget_name> to track a budget consumption for a policy in an account level. To enable the budget store 400 to handle sharded deployments, a BudgetConsumptionDPO DPO can track a data consumer's budget consumption total, and this DPO can be instantiated and fully managed in the data consumer's shard deployment. As noted, the key can be <consumerAccountId, providerPolicyId, budget_name>. Lifecycle management can be achieved using a consumer-side background task for garbage collection. Garbage collection can be performed when the data provider policy has been purged. As an optimization, an embodiment can also garbage-collect if the budget is at 100% in a current window. The data provider can be read this from the BudgetConsumptionDPO DPO.

To handle data provider-driven budget adjustments, an embodiment can use a BudgetAdjustmentDPO DPO, which can be written by the data provider and read by the data consumer. The key for this DPO can be something like <providerPolicyID, consumerAccountId, budget_name>. The data consumer's actual budget consumption can be their total consumption minus the total adjustments in the current window. To ensure that all consumption and updates are applied against the correct budget window, all budget updates to both BudgetConsumptionDPO and BudgetAdjustmentDPO can include timestamps when the update is performed. Additionally, these timestamps can be used to support sliding windows. In a single-account case, an embodiment can use both BudgetConsumptionDPO and BudgetAdjustmentDPO in the same shard for uniformity.

The following TABLE 23 describes an example structure of BudgetConsumptionDPO that stores the budget consumption. This DPO can be writable by the data consumer account and can be readable by the data provider account.

```
TABLE 23
  @DPOEntity( schemaVersion = 1, slices =
  {
    @DPOSlice(
      name = BY_PRINCIPAL_ACCOUNT, // Slice
      for updating the total RDP curve keys =
      {
        FIELD_PRINCIPAL_ACCOUNT_ID, // id of
        the consumer account.
        FIELD_POLICY_ACCOUNT_ID,
        FIELD_POLICY_ID, // id
        of the policy.
        FIELD_PRIVACY_BUDGET_NA
        ME, // name of the
        budget.
      },
      values =
      {
        FIELD_MODIFIED_ON,
        FIELD_RDP_CURVE_TIMESTAMP, // Time when
        the RDP_CURVE was last updated.
        FIELD_RDP_CURVE, // RDP curve
        representing the total budget spent since
        the
                // last reset period.
                // This is a fixed length array of
                doubles encoded as JSON.
                // Note: we can store it as a
                binary blob encoded as ASCII.
                // Size: numAlphas *
                sizeof(double)
            },
            primary=true
          ),
          @DPOSlice(
          name = BY_POLICY_ID, keys =
          {
          FIELD_POLICY_ACCOUNT_ID, FIELD_POLICY_ID,
          FIELD_PRIVACY_BUDGET_NAME,
          FIELD_PRINCIPAL_ACCOUNT_ID,
            },
            values =
            {
          FIELD_QUERY_ID, FIELD_MODIFIED_ON,
          FIELD_RDP_CURVE_TIMESTAMP, FIELD_RDP_CURVE,
          FIELD_DELETED_ON,
            },
          @DPOSlice(
            name =
            CHANGELOG_SLICE,
            // Slice for
            snowhouse export
            keys =
            {
              FIELD_MODIFIED_ON,
              FIELD_PRINCIPAL_ACCOUNT_ID, // id
              of the consumer account.
              FIELD_POLICY_ACCOUNT_ID,
              FIELD_POLICY_ID
              , // id of the
              policy.
              FFIELD_PRIVACY_{—}
              BUDGET_NAME
            },
            values = { FIELD_DELETED_ON, FIELD_QUERY_ID,
            FIELD_RDP_CURVE_TIMESTAMP, FIELD_RDP_CURVE,
            },
          )
          }
        )
public interface BudgetConsumptionDPO extends DPOObject
```

The following TABLE 24 describes an example structure of BudgetAdjustmentDPO that comprises a budget limit (epsilon, delta, window) and any ephemeral adjustments to epsilon that an administrator makes. These DPOs are written by the data provider account and read by the data consumer account.

```
TABLE 24
@DPOEntity( schemaVersion = 1, slices =
{
  @DPOSlice(
    name = BUDGET_SLICE,
    keys =
    {
      FIELD_POLICY_ACCOUNT_ID, // id of the consumer
      account. FIELD_POLICY_ID, // id of the policy.
      FIELD_PRIVACY_BUDGET_NAME,
    },
    values =
    {
      FIELD_LAST_MODIFIED, // Timestamp for latest
      modification. Long,
      FIELD_ADJUSTMENT_EPSILON_LIMIT, // Epsilon limit.
      Optional<Double>. FIELD_ADJUSTMENT_DELTA, //
      Improbability. Optional<Double>.
      FIELD_ADJUSTMENT_WINDOW, // Optional<JSONObject>,
      Details TBD
          },
          primary=true
        ),
        ),
        @DPOSlice(
          name = CHANGELOG_SLICE,
          keys =
          {
            FIELD_LAST_MODIFIED,
            FIELD_POLICY_ID
            , // id of the
            policy.
            FIELD_PRIVACY_B
            UDGET_NAME,
            FIELD_POLICY_ACCOUNT_ID, // id of the
            consumer account.
          },
          values =
          {
            FIELD_DELETED_ON,
            FIELD_ADJUSTMENT_EPSILON_LIMIT, //
            Epsilon limit. Optional<Double>.
            FIELD_ADJUSTMENT_DELTA, //
            Improbability. Optional<Double>,
            FIELD_ADJUSTMENT_WINDOW, //
            Optional<JSONObject>. Details TBD
        },
      ),
    }
  )
public interface BudgetAdjustmentDPO extends
DPOObject
```

To handle budget refunds, an embodiment can use a BudgetRefundDPO DPO, which can be written by the data provider and read by the data consumer. The following TABLE 25 describes an example structure of BudgetRefundDPO that facilitate a budget refund.

```
TABLE 25
@DPOEntity(
        schemaVersion = 1,
        slices =
        {
        @DPOSlice(
        name = BY_POLICY, keys =
        {
          FIELD_POLICY_ACCOUNT_ID, // id of the
          consumer account. FIELD_POLICY_ID, //
          id of the policy.
          FIELD_PRIVACY_BUDGET_NA
          ME,
          FIELD_PRINCIPAL_ACCOUNT
          _ID
        },
        values =
        {
          FIELD_MODIFIED_ON, long // last time any changes
          were made to this DPO
          FIELD_REFUND_EPSILON_TIMESTAMP long // last
          time the refund was updated for budget
window logic.
          FIELD_REFUND_EPSILON, // total budget refund in
            // approximate-DP epsilon
            units. double.
        },
        primary=true
      ),
      ),
      @DPOSlice(
        name = CHANGELOG_SLICE,
        keys =
        {
          FIELD_MODIFIED_ON,
          FIELD_POLICY_ID, // id
          of the policy.
          FIELD_PRIVACY_BUDGET_NA
          ME,
          FIELD_POLICY_ACCOUNT_ID, // id of the consumer
          account.
        },
        values =
        {
          FIELD_DELETED_ON, // null when not
          deleted
          FIELD_REFUND_EPSILON_TIMESTAMP, //
          long
          FIELD_REFUND_EPSILON, // total budget adjustment
          in
            // approximate-DP epsilon
            units. double.
        },
      ),
    }
  )
  public interface BudgetAdjustmentDPO extends DPOObject
```

Some embodiments use an alpha grid to store a RDP curve at a set of points {α}. The alphas chosen can comprise, for example, 1.5, 1.75, 2, 2.5, 3, 4, 5, 6, 8, 16, 32, 64, 128, 256, 512, 1024, Infinity.

Privacy budget spent can be updated and computed from fields in the DPOs. The logic for computing the total budget consumption can comprise the following. (1) The administrator can create a differential privacy (DP) policy, where the DP policy can comprise static values for epsilon, delta, and window. (2) Optionally, the administrator can override the fields for a specific privacy budget, populate the BudgetDPO with the adjustment timestamp and epsilon adjustment being null, and use a system call to cause an update. (3) When an analyst executes a differentially private query, a privacy engine first checks whether there is sufficient privacy budget on the DP policy to execute the query. (4) If the check function returns TRUE, then it's plausible that the differentially private query can be executed with the provided privacy budget. (5) After the private computation (e.g., differentially private query) is executed, the privacy engine can charge the privacy budget before returning the result to the analyst. (6) To avoid race-conditions and prevent the analyst from executing many DP queries in parallel, the privacy engine can re-run the privacy budget check above, and the privacy engine will not return the private answer (e.g., differentially private query result) to the analyst if the result is FALSE. (7) If any major mistakes occur within the time window of the privacy budget, the administrator can increase the epsilon adjustment via a system call.

FIG. 5 illustrates example cloning behaviors 500 of schemas with respect to differential privacy (DP) policies, in accordance with some embodiments. FIG. 6 illustrates example cloning behaviors 600 of tables with respect to DP policies, in accordance with some embodiments. For various embodiments, when a DP policy is cloned, the state of the budget stores whose identifiers the DP policy can evaluate to are not cloned but created fresh. For instance, as illustrated in FIGS. 5 and 6, when a privacy policy P is cloned into P′, the state does not carry over—the state (e.g., budget consumption, in particular, but also budget adjustments and refunds) of the state of P′ is created fresh. In order to avoid accidentally cloning a privacy policy and thus duplicating the amount of privacy budget that analysts have, administrators can keep differential privacy (DP) policies away from data, in a centralized location that will not be cloned.

Referring now the cloning behaviors 500 of schemas in FIG. 5, a schema 502-1 is cloned to generate a schema clone 502-2, and a schema 504-1 is cloned to generate a schema clone 504-2. According to some embodiments, the schema 502-1 comprises a table 512-1 and a differential privacy policy 510-1 associated with the schema 502-1, and the schema clone 502-2 comprises a table clone 512-2 and a differential privacy policy clone 510-2 associated with the table clone 512-2, where the table clone 512-2 is a clone of the table 512-1 and where the differential privacy policy clone 510-2 is a clone of the differential privacy policy 510-1. Additionally, according to various embodiments, the schema 504-1 comprises a table 520-1, and the schema clone 504-2 comprises a table clone 520-2, where a differential privacy policy 530 (that is external to the schema 504-1) is originally associated with the table 520-1, the differential privacy policy 530 remains external to the schema 504-1 after the cloning process, and the differential privacy policy 530 is associated with the table clone 520-2 of the schema clone 504-2 after the cloning process.

Referring now the cloning behaviors 600 of tables in FIG. 6, a schema 602 comprises a table 612-1 and a differential privacy policy 610 associated with the table 612-1. According to some embodiments, after the table 612-1 is cloned to generate a table clone 612-2 within the schema 602, the differential privacy policy 610 originally associated with the table 612-1 is also associated with the table clone 612-2. As also shown in FIG. 6, a schema 604 comprises a table 622-1 and a differential privacy policy 620 associated with the table 622-1. According to some embodiments, after the table 622-1 is cloned to generate a table clone 622-2 within a schema2 606, the differential privacy policy 620 originally associated with the table 612-1 is also associated with the table clone 622-2 while the differential privacy policy 620 remains within the schema 604. As also shown, a table 632-1 of a schema 608 is cloned to generate a table clone 632-2 within a schema2 610. According to various embodiments, after the cloning process, a differential privacy policy 630 that is external to the schema 608 and originally associated with the table 632-1 remains external to the schema 608, is external to the schema2 610, and is associated with both the table 632-1 of the schema 608 and the table clone 632-2 of the schema2 610.

For some embodiments, one or more of the following rules describe behavior of cloning in terms of pre-conditions and post-conditions. If a differential private (DP) policy P is attached to table T, and both live in the same schema, then after the execution of the command CREATE TABLE T_CLONE AS CLONE T, P will be attached to T_CLONE (e.g., privacy policy P is not cloned). If a DP policy SH.P is attached to table SH.T, and both live in the same database, then after the execution of the command CREATE SCHEMA SH_CLONE AS CLONE SH, policy SH_CLONE.P will be attached to table SH_CLONE.T (e.g., privacy policy SH.P is cloned into SH_CLONE.P). If a DP policy SH_POLICY.P is attached to table SH_TABLE.T, then after the execution of the command CREATE SCHEMA SH_TABLE_CLONE AS CLONE SH_TABLE, SH_POLICY.P will be attached to SH_TABLE_CLONE.T (e.g., privacy policy SH_POLICY.P is not cloned). If a DP policy DB.SH.P (or DB.SH1.P) is attached to DB.SH.T, then after the execution of the command CREATE DATABASE DB_CLONE AS CLONE DB, DB_CLONE.SH.P (or DB_CLONE.SH_1.P) will be attached to DB.SH.T (e.g., privacy policy DB.SH.P (or DB.SH1.P) is cloned into DB_CLONE.SH.P (or DB_CLONE.SH_1.P)). If a DP policy DB_POLICY.SH.P is attached to DB_TABLE.SH.T, then after the execution of the command CREATE DATABASE DB_CLONE AS CLONE DB_TABLE, privacy policy DB_POLICY.SH.P will be attached to table DB_CLONE.SH.T (e.g., privacy policy DB_POLICY.SH.P is not cloned).

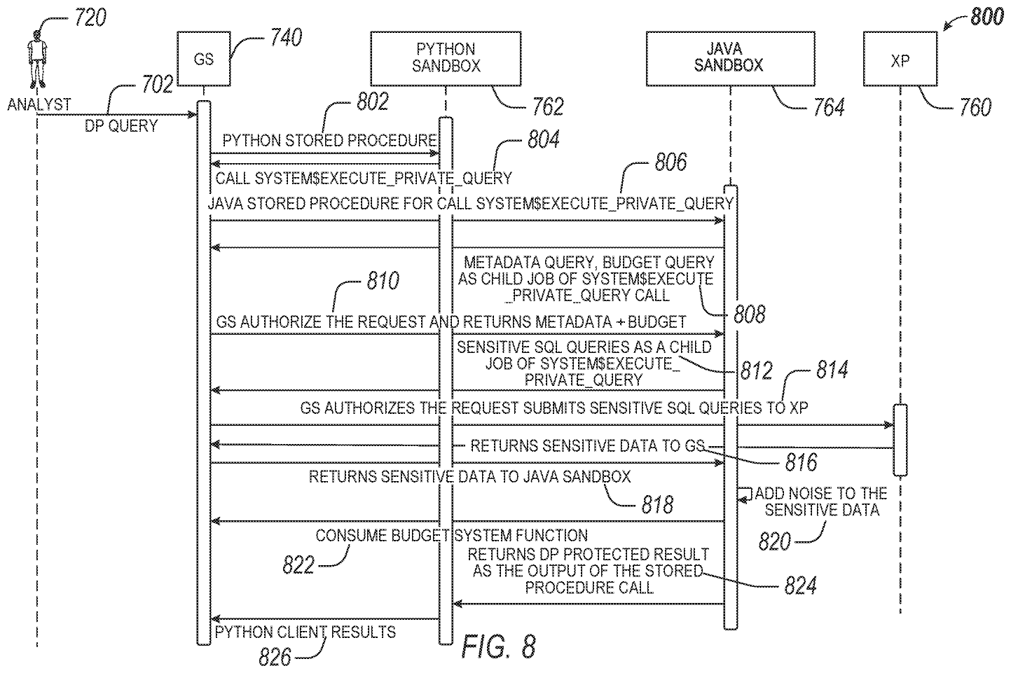

FIGS. 7 and 8 illustrate examples of implementing differentially privacy (DP) features with respect to a data system, in accordance with some embodiments. According to some embodiments, a data system implements DP features by integrating one or more of the following: a privacy engine; a computation application; and an application programming interface (API) (e.g., Python API) through which a user (e.g., analyst 720) can submit a differentially private query 702 and receive a differentially private query result (710). In particular, as illustrated by FIG. 7, a data system 700 can comprise a software development kit (SDK) that provides the API (e.g., Python API) for a user (e.g., analyst) submit a differentially private query (702), and a privacy engine configured to apply differential privacy (DP) to non-differentially private query results. The data system 700 of FIG. 7 represents a data system that can support a Python client 742 (e.g., in Python worksheet) use of DP features, and that integrates DP features into the data system. According to FIG. 7, DP components are packaged into an internal system Java stored procedure SYSTEM$EXECUTE_PRIVATE_QUERY(‘< . . . >’) where: 1. the stored procedure receives the request from the Python_SDK, i.e., for each analyst (e.g., 702) request Python_SDK internally calls this procedure; and 2. the stored procedure then returns the differentially private result (710) to the Python_SDK. The components illustrated in FIG. 7 are described in the following TABLE 26.

TABLE 26

| Components | Required Modification |
|---|---|
| Python_SDK | This is the user interface where an analyst can |
| | submit one or more DP queries on sensitive |
| | data stored in a dataset (e.g., database) from a |
| | Python client (742) to a Python sandbox (762). |
| | The Python_SDK then formats the request and |
| | internally it will call |
| | SYSTEM$EXECUTE_PRIVATE_QUERY. |
| Privacy_Engine | This is a component that implements one or |
| (766) | more differential privacy algorithms. This |
| | can be a library, and can be compiled to |
| | native code privacy_engine.so that can be |
| | invoked from a system procedure to generate |
| | private results. It can generate a SQL |
| | statement (e.g., invoke a Java method to |
| | submit a SQL query to a data system as a |
| | child job) to obtain data from dataset (e.g., |
| | database backend), can add noise to the SQL |
| | query result, and can returns the noisy/DP |
| | result. It can also charge a budget for the |
| | operation. |
| SYSTEM$EXECUTE_{—} | This is a system call that sets up the |
| PRIVATE_{—} | environment to execute queries from |
| QUERY( ) | privacy_engine. |
| procedure | It loads the privacy_engine.so in the |
| (new component) | compute app (768) (e.g., JVM). |
| | It then passes the request to the |
| | privacy engine to calculate the |
| | differentially private result and |
| | returns the differentially private |
| | result to the caller. |

FIG. 8 illustrates an example analyst workflow 800 in accordance with some embodiments. The operations of the example workflow are described in the following TABLE 27.

TABLE 27

| Operations | Description | Interacting component |
|---|---|---|
| Operation | A Python stored procedure is submitted | Global Services (GS) node |
| 802 | to execute analyst request | (740) −> python_sandbox |
| | using Python_SDK from | (762) on Execution Platform |
| | Python client (742) | (XP) node (760) |
| Operation | Python_SDK invokes the system | python_sandbox (762)−> GS |
| 804 | stored procedure (SP) with request | node (740) |
| | payload | |
| | SYSTEM$EXECUTE_PRIVACY_QUERY | |
| | (‘<payload>’) | |
| Operation | The request then forward to XP in | IGS node (740) −> |
| 806 | Java_sandbox (764) | java_sandbox (764) |
| Operations | Get sensitive table metadata: | privacy_engine (766) −> |
| 808 & 810 | bounds(min, max), etc. | compute_app (768)−> GS |
| | Get the privacy loss of the | node (740) |
| | user on this table | privacy_engine (766) −> |
| | | compute_app (768)−> GS |
| | | node (740) |
| Operations | Executes the query to read the | privacy_engine (766) −> |
| 812 & 814 & | sensitive data. For instance, | compute_app (768)−> GS |
| 816 & 818 | SELECT COUNT(*) FROM | node (740) |
| | db.sch.employee WHERE | |
| | age >50; | |
| Operation | Add DP noise to the result of the | privacy_engine (766) |
| 820 | sensitive query | |
| Operation | Update the privacy loss of the user | privacy_engine (766) −> |
| 822 | | compute_app (768)−> GS |
| | | node (740) |
| Operations | Return DP protected result | Java SP −> . . . −> Analyst |
| 824 & 826 | to the user | (720) |

An example global services (GS) node can be implemented by the compute service manager 108 of FIG. 1, and an example execution platform (XP) node can be implemented by the execution platform 110 of FIG. 1. As shown, privacy_engine is hosted separately from the Python sandbox. In doing so, privacy_engine can be hosted as a trusted code (e.g., In Java sandbox that is separate from the Python sandbox) to lift certain restrictions, permit loading of libraries (such as privacy_engine.so), and privacy_engine can be run in a separate stored procedure. To enable the Java sandbox (e.g., Java Virtual Machine (JVM)) to load libraries (e.g., loading privacy_engine as native library), an embodiment can implement at least one of the following options described by TABLE 28.

TABLE 28

| Options | Pros |
|---|---|
| (Option 1) | Generic property that will help |
| Introduce a function property | loading any library in the future |
| TRUSTED_SYSTEM_PROC for | for the trusted system |
| SYSTEM$EXECUTE_PRIVATE_{—} | procedure |
| QUERY( ). That | |
| property will allow loading all native | |
| library in a JVM | |
| (Option 2) | Granular enforcement to provide |
| Whitelist the privacy_engine native | better maintainability |
| library in Java SecurityManager so | |
| that it can be loaded when needed by | |
| a Java procedure. | |
| Option 3: | Very restrictive |
| Combine both option 1 and option 2 | |
| where the system procedure can only | |
| load selected libraries in | |
| SecurityManager. | |

The privacy engine (in Java sandbox) can trigger some child jobs that a regular user query may not be able to perform: 1. Query to read sensitive data from the tables/views that is protected by differential privacy; and 2. Query that reads/updates a budget of the analyst that the calling user may not have access to. For some embodiments, the stored procedure inherits CALLER privileges and adds additional privilege to bypass privacy enforcement and to update the budget.

By implementing a data system in accordance with FIG. 8, some embodiments can avoid an authentication for the query generated by privacy_engine (since the query is submitted as child job of a stored procedure). Some embodiments can provide a secure solution that inherits security from existing sandbox security. Additionally, some embodiments can more easily monitor and debug since the queries from privacy_engine are submitted as child jobs of a stored procedure instead of creating a new job.

The following TABLE 29 describes some options for implementing authorization for the stored procedure SYSTEM$EXECUTE_PRIVATE_QUERY( ).

TABLE 29

| | | Child Job |
|---|---|---|
| Options | Initialization process | authorization |
| Option 1: Special | SYSTEM$EXECUTE_PRIVATE_{—} | When a child |
| Job flag to allow | QUERY (<LY_AST>) is | job tries to run |
| by-passing privacy | declared as CALLER right | a sensitive |
| enforcement and | stored procedure. Hence, the | query on a |
| budget function | original callers authorization | table, |
| call | context would be propagated | |
| | to the child jobs of the stored | |
| | procedure. Hence, the child | |
| | job should be able to access | |
| | the tables that are authorized to | |
| | the caller. | |
| | When the user calls | |
| | SYSTEM$EXECUTE_PRIVATE_{—} | |
| | QUERY, during name | |
| | resolution, the compiler sets a | |
| | flag | |
| | FLAG_DIFFERENTIAL_PRIVACY_{—} | |
| | EXECUTION to the | |
| | job. This flag will then | |
| | propagate to each child job. | |
| enforcement and | right stored procedure. Hence, | it will be |
| budget function | the original callers | authorized |
| call | authorization context would be | since the |
| | propagated to the child jobs of | authorization |
| | the stored procedure. Hence, | context is the |
| | the child job should be able to | same as the |
| | access the tables that are | calling user. |
| | authorized to the caller. | The flag |
| | When the user calls | FLAG_DIFFERENTIAL_{—} |
| | SYSTEM$EXECUTE_PRIVATE_{—} | PRIVACY_EXECUTION |
| | QUERY, during name | would allow |
| | resolution, the compiler sets | the job to skip |
| | a flag | the privacy |
| | FLAG_DIFFERENTIAL_PRIVACY_{—} | enforcement. |
| | EXECUTION to the | When a child |
| | job. This flag will then | job try to |
| | propagate to each child job. | update budget |
| | | of the user |
| | | using a system |
| | | function, let's |
| | | say, |
| | | SYSTEM$UPDATE_{—} |
| | | BUDGET( ), the |
| | | update is |
| | | allowed for the |
| | | job that has |
| | | flag |
| | | FLAG_DIFFERENTIAL_{—} |
| | | PRIVACY_EXECUTION |
| Option 2: A | A special non-grantable-by- | When a child |
| privileged based | user privilege | job tries to run |
| approach where | ‘ALLOWPRIVACYENGINE | a sensitive |
| each invocation of | ACTION’ on account is | query on a |
| this stored | created and granted to an | table, it will be |
| procedure will | internal system role | authorized as |
| activate an internal | ‘PRIVACY_ENGINER_RL’. | the context is |
| privilege that | This role will be hidden and | the same as the |
| would allow the | cannot be granted by the | calling user |
| following: | customer. | and the |
| 1. The privilege | When a child job is executed | privilege |
| will allow | from | ‘ALLOWPRIVACYENGINE |
| update/get | SYSTEM$EXECUTE_PRIVATE_{—} | ACTION’ will |
| privacy | QUERY(<LY_AST>) the | allow private |
| budget | role is PRIVATEACCESSOR | access on the |
| 2. The privilege | activated for the job when | table. |
| will allow | setting up execution context | When a child |
| sensitive | | job tries to |
| query on the | | update the |
| protected | | budget of the |
| table | | user using a |
| | | system |
| | | function, let's |
| | | say, |
| | | SYSTEM$UPDATE_{—} |
| | | BUDGET( ), the |
| | | update is |
| | | allowed since |
| | | the privilege |
| | | MANAGE$PRIVATE_{—} |
| | | QUERY will be |
| | | checked on the |
| | | account. |

Option 1 represents a lightweight mechanism and is limited to the child job of EXECUTE_PRIVATE_QUERY( ) procedure. Option 2 is based on traditional RBAC and adding more privilege to the procedure beyond the caller role.

Regarding role and privilege and privacy engine, a data system can implement a ALLOWPRIVACYENGINEACTION internal privilege for the privacy engine, where the role may not be visible to an end-user and restricted from being granted. Additionally, a data system can implement a system role (e.g., called PRIVACY_ENGINE role) granted the privilege of ALLOWPRIVACYENGINEACTION. This role may not be visible to an end-user or granted to another role/user in the system.

For some embodiment, the system procedure for the privacy engine (e.g., called SYSTEM$PRIVACY_ENGINE_INTERNALS) will have following property: a property that prevents the procedure from directly being called by an end-user and only permits the system procedure to be called/invoked by another system procedure. At runtime, when a child job of SYSTEM$PRIVACY_ENGINE_INTERNALS is initialized, a global authorization will be created loaded with the ID of the PRIVACY_ENGINE_RL and store in it. Eventually, when SYSTEM$UPDATE_BUDGET_AT_RUNTIME is called (e.g., to update or charge a privacy budget of a user), the data system can examine whether ALLOWPRIVACYENGINEACTION privilege is granted to the activated roles in the account and authorize if granted.

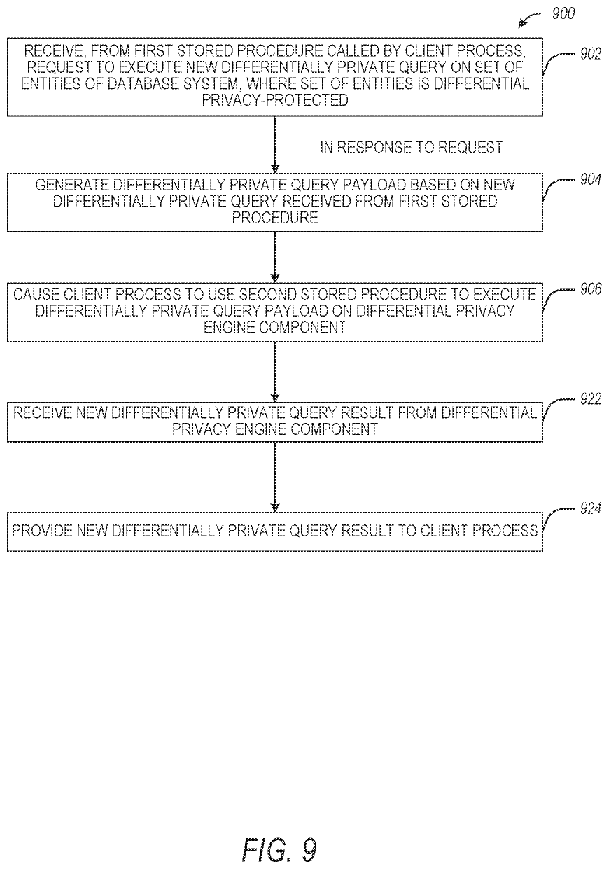

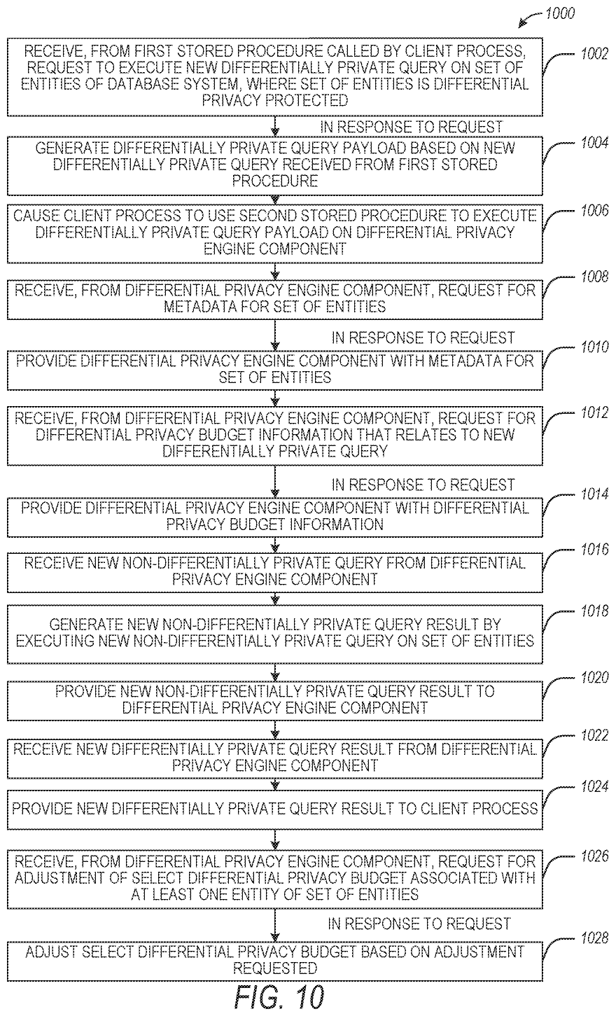

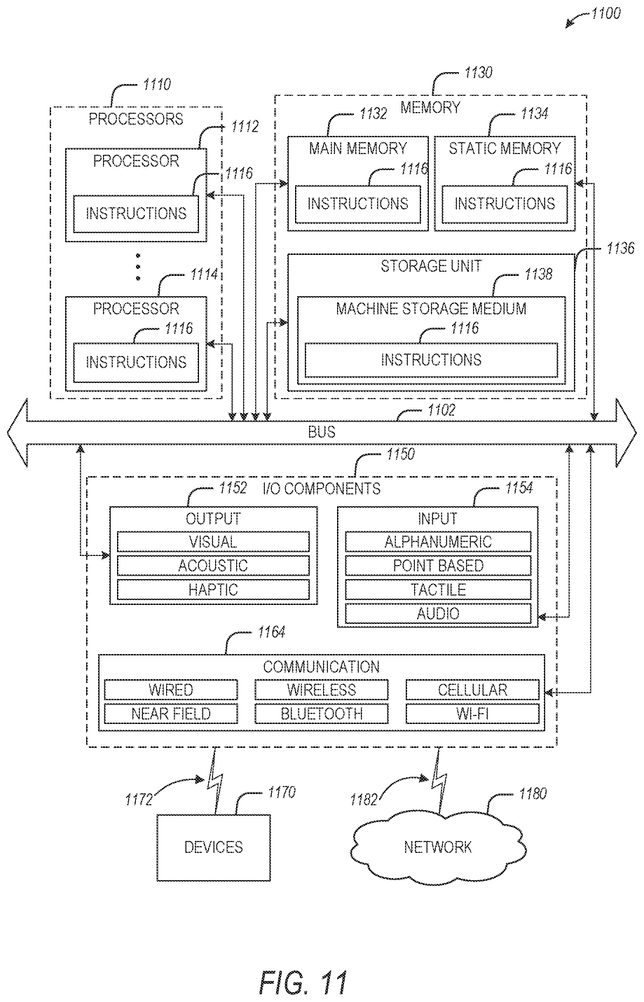

FIGS. 9 and 10 are flow diagrams illustrating example methods 900, 1000 for using one or more stored procedures to implement differential privacy on a database system, in accordance with some embodiments of the present disclosure. Any of methods 900, 1000 may be embodied in computer-readable instructions for execution by one or more hardware components (e.g., one or more processors) such that the operations of methods 900, 1000 may be performed by components of the network-based database system 102, such as a differential privacy (DP) protection manager 132 or computing device which may be implemented as machine 1100 of FIG. 11 and may be configured with an application connector performing the disclosed functions. Accordingly, each of methods 900, 1000 is described below, by way of example with reference thereto. However, it shall be appreciated that any of methods 900, 1000 may be deployed on various other hardware configurations and is not intended to be limited to deployment within the network-based database system 102.

At operation 902, a processing device (e.g., comprising a hardware processor) receives, from a first stored procedure (e.g., Python stored procedure at operation 802 in FIG. 8) called (e.g., executed) by a client process (e.g., Python client 742), a request to execute a new differentially private query on a set of entities of a database system, where the set of entities is differential privacy-protected (DP-protected). According to some embodiments, the first stored procedure (e.g., Python stored procedure) is an Application Programming Interface (API) of a software development kit (SDK) (e.g., Python SDK) accessible to the client process. Additionally, in response to the call, the first stored procedure (e.g., API) can be executed within a sandbox execution environment (or sandbox environment), such as a Python sandbox (e.g., 762). For some embodiments, a given entity is a table of a database, or a view of a table of a database. Additionally, for some embodiments, a given entity is differential privacy-protected when a differential privacy policy is associated with (e.g., applied or attached to) the given entity. The client process can be associated with a user (e.g., analyst 720), such as one having an analyst role. Further, the new differentially private query can be submitted to the client process by a user (e.g., analyst 720) that has a differentially private query execution privilege for the set of entities (e.g., the user can execute a differentially private query on the set of entities) and that does not have a non-differentially private query execution privilege for the set of entities (i.e., the user can execute a non-differentially private query on the set of entities).

During operation 904, the processing device generates a differentially private query payload based on the new differentially private query received from the first stored procedure. Thereafter, at operation 906, the processing device causes the client process (e.g., Python client 742) to use (e.g., execute) a second stored procedure to execute the differentially private query payload on a differential privacy engine component. In response, the client process (e.g., Python client 742) can use (e.g., execute) the second stored procedure (e.g., Java stored procedure at operation 806 in FIG. 8). According to some embodiments, the first stored procedure (e.g., executing within Python sandbox 762) causes the processing device to perform operation 904, 906, or both. For some embodiments, the processing device causes the client process (e.g., Python client 742) to use (e.g., execute) the second stored procedure by performing a system call (e.g., a system call SYSTEM$EXECUTE_PRIVATE_QUERY( ) at operation 804 in FIG. 8) on the client process with the differentially private query payload as a parameter of the system call, where the system call is configured to cause the second stored procedure to execute on the client process with the differentially private query payload as a parameter of the second stored procedure. For some embodiments, the second stored procedure (e.g., Java stored procedure) is configured to cause the differential privacy engine component (e.g., privacy engine 766) to load and execute within a sandbox execution environment (e.g., Java sandbox 764). According to various embodiments, the differential privacy engine component has the non-differentially private query execution privilege for the set of entities (e.g., the one the user lacks). After the differential privacy engine component (e.g., privacy engine 766) is loaded and executing in the sandbox execution environment (e.g., Java sandbox 764), the second stored procedure (e.g., Java stored procedure) can provide the differentially private query payload to the differential privacy engine component. The differential privacy engine component can be configured to generate a new differentially private query result by executing the new differentially private query on the set of entities based on the differentially private query payload provided to the differential privacy engine component. More regarding the process by which the differential privacy engine component generates the new differentially private query result is described with respect to method 1000 of FIG. 10.

Eventually, at operation 922, the processing device receives the new differentially private query result from the differential privacy engine component (e.g., operation 824 in FIG. 8) and, at operation 924, the processing device provides the new differentially private query result to the client process (e.g., operation 826 in FIG. 8). According to some embodiments, the new differentially private query result is provided to the client process (e.g., Python client 742) as an output of the first stored procedure (e.g., Python stored procedure at operation 802 in FIG. 8).

Referring now to method 1000 of FIG. 10, operations 1002 through 1006 of method 1000 are respectively similar to operations 902 through 906 of method 900 as described with respect to FIG. 9. For some embodiments, after operation 1006, the differential privacy engine component (e.g., privacy engine 766) is loaded and executing in the sandbox execution environment (e.g., Java sandbox 764). At operation 1008, the processing device receives, from the differential privacy engine component, a request for metadata for the set of entities, where the request is generated by the differential privacy engine component (e.g., privacy engine 766) during the differential privacy engine component's execution of the new differentially private query on the set of entities based on the differentially private query payload. In response to the request for the metadata, at operation 1010, the processing device provides the differential privacy engine component (e.g., privacy engine 766) with the metadata for the set of entities. The differential privacy engine component can be configured to execute the new differentially private query on the set of entities based on the differentially private query payload and based on the metadata for the set of entities provided by the processing device.

At operation 1012, the processing device receives, from the differential privacy engine component, a request for differential privacy budget information that relates to the new differentially private query, where the request is generated by the differential privacy engine component (e.g., privacy engine 766) during the differential privacy engine component's execution of the new differentially private query on the set of entities based on the differentially private query payload. In response to the request for the differential privacy budget information, at operation 1014, the processing device provides the differential privacy engine component (e.g., privacy engine 766) with the differential privacy budget information. The differential privacy engine component can be configured to execute the new differentially private query on the set of entities based on the differentially private query payload and based on the differential privacy budget information provided by the processing device.

Examples of performing operations 1008 and 1012 of method 1000 are represented in FIG. 8 by single operation 808, and examples of performing operations 1010 and 1014 are represented in FIG. 8 by single operation 810.

Continuing with FIG. 10, at operation 1016, the processing device receives a new non-differentially private query from the differential privacy engine component (e.g., privacy engine 766), where the new non-differentially private query is generated by the differential privacy engine component based on the differentially private query payload. An example of operation 1016 is represented in FIG. 8 by operation 812. For some embodiments, the differential privacy engine component (e.g., privacy engine 766) generates the new non-differentially private query using at least a portion of the metadata provided to the differential privacy engine at operation 1010. During operation 1018, the processing device generates a new non-differentially private query result by executing the new non-differentially private query on the set of entities (e.g., operations 814 and 816 in FIG. 8). For various embodiments, the new non-differentially private query on behalf of the differential privacy engine based on the differential privacy engine privilege to execute non-differentially private queries on the set of entities (e.g., represented by the GS authorization of operation 814 in FIG. 8). After operation 1018, at operation 1020, the processing device provides the new non-differentially private query result to the differential privacy engine component (e.g., privacy engine 766). The differential privacy engine component can be configured to receive the non-differentially private query result from the processing device and generate a new differentially private query result based on the new non-differentially private query result by adding noise to the new non-differentially private query result.

As shown, operations 1022 and 1024 can follow after operation 1020. According to various embodiments, operations 1022 and 1024 of method 1000 are respectively similar to operations 922 and 924 of method 900 as described with respect to FIG. 9.

At operation 1026, the processing device a request for an adjustment (e.g., charging) of a select differential privacy budget associated with at least one entity of the set of entities (e.g., operation 822 in FIG. 8). For various embodiments, the adjustment requested is determined by the differential privacy engine component (e.g., privacy engine 766) based on the differential privacy engine component's execution of the new differentially private query on the set of entities based on the differentially private query payload. For instance, the differential privacy engine component can determine the adjustment (e.g., measure consumption of privacy budget) based on a type or amount of noise added to the non-differentially private query result to generate the differentially private query result. In response to the request, at operation 1028, the processing device adjusts the select differential privacy budget (e.g., in the privacy budget store 400 of FIG. 4) based on the adjustment requested.

FIG. 11 illustrates a diagrammatic representation of a machine 1100 in the form of a computer system within which a set of instructions may be executed for causing the machine 1100 to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute any one or more operations of any one or more of the methods described herein. As another example, the instructions 1116 may cause the machine 1100 to implement portions of the data flows described herein. In this way, the instructions 1116 transform a general, non-programmed machine into a particular machine 1100 that is specially configured to carry out any one of the described and illustrated functions in the manner described herein.

In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 includes processors 1110, memory 1130, and input/output (I/O) components 1150 configured to communicate with each other such as via a bus 1102. In an example embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors 1110 that may comprise two or more independent processors (sometimes referred to as “cores”) that may execute instructions 1116 contemporaneously. Although FIG. 11 shows multiple processors 1110, the machine 1100 may include a single processor with a single core, a single processor with multiple cores (e.g., a multi-core processor), multiple processors with a single core, multiple processors with multiple cores, or any combination thereof.

The memory 1130 may include a main memory 1132, a static memory 1134, and a storage unit 1136, all accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136 (e.g., on machine storage medium 1138), within at least one of the processors 1110 (e.g., within the processor's cache memory), or any suitable combination thereof, during execution thereof by the machine 1100.

The I/O components 1150 include components to receive input, provide output, produce output, transmit information, exchange information, capture measurements, and so on. The specific I/O components 1150 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, and other communication components to provide communication via other modalities. The devices 1170 may be another machine or any of a wide variety of peripheral devices (e.g., a peripheral device coupled via a universal serial bus (USB)). For example, as noted above, the machine 1100 may correspond to any one of client devices 114, the compute service manager 108, the execution platform 110, and the devices 1170 may include any other of these systems and devices.

The various memories (e.g., 1130, 1132, 1134, and/or memory of the processor(s) 1110 and/or the storage unit 1136) may store one or more sets of instructions 1116 and data structures (e.g., software) embodying or utilized by any one or more of the methodologies or functions described herein. These instructions 1116, when executed by the processor(s) 1110, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1180 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single CarrierRadio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: receiving, from a first stored procedure called by a client process, a request to execute a new differentially private query on a set of entities of a database system, the set of entities being differential privacy-protected, the new differentially private query being submitted to the client process by a user that has a differentially private query execution privilege for the set of entities and that does not have a non-differentially private query execution privilege for the set of entities; generating a differentially private query payload based on the new differentially private query received from the first stored procedure; causing the client process to use a second stored procedure to execute the differentially private query payload on a differential privacy engine component, the second stored procedure being configured to: cause the differential privacy engine component to load and execute within a sandbox execution environment, the differential privacy engine component having the non-differentially private query execution privilege for the set of entities; after the differential privacy engine component is loaded and executing in the sandbox execution environment, provide the differentially private query payload to the differential privacy engine component, the differential privacy engine component being configured to generate a new differentially private query result by executing the new differentially private query on the set of entities based on the differentially private query payload provided to the differential privacy engine component; receiving the new differentially private query result from the differential privacy engine component; and providing the new differentially private query result to the client process.

In Example 2, the subject matter of Example 1 includes, wherein the causing of the client process to use the second stored procedure to execute the differentially private query payload on the differential privacy engine comprises: performing a system call on the client process with the differentially private query payload as a parameter of the system call, the system call being configured to cause the second stored procedure to execute on the client process with the differentially private query payload as a parameter of the second stored procedure.

In Example 3, the subject matter of Examples 1-2 includes, wherein the request is a first request, and wherein the operations comprise: receiving, from the differential privacy engine component, a second request for metadata for the set of entities, the second request being generated by the differential privacy engine component during the differential privacy engine component's execution of the new differentially private query on the set of entities based on the differentially private query payload; and in response to the second request, providing the differential privacy engine component with the metadata for the set of entities, the differential privacy engine component being configured to execute the new differentially private query on the set of entities based on the differentially private query payload and the metadata for the set of entities.

In Example 4, the subject matter of Examples 1-3 includes, wherein the request is a first request, and wherein the operations comprise: receiving, from the differential privacy engine component, a second request for differential privacy budget information that relates to the new differentially private query, the second request being generated by the differential privacy engine component during the differential privacy engine component's execution of the new differentially private query on the set of entities; and in response to the second request, providing the differential privacy engine component with the differential privacy budget information, the differential privacy engine component being configured to execute the new differentially private query on the set of entities based on the differentially private query payload and the differential privacy budget information.

In Example 5, the subject matter of Examples 1-4 includes, wherein the operations comprise: receiving a new non-differentially private query from the differential privacy engine component, the new non-differentially private query being generated by the differential privacy engine component based on the differentially private query payload; generating a new non-differentially private query result by executing the new non-differentially private query on the set of entities; and providing the new non-differentially private query result to the differential privacy engine component, the differential privacy engine component being configured to generate the new differentially private query result by adding noise to the new non-differentially private query result.

In Example 6, the subject matter of Examples 1-5 includes, wherein the request is a first request, and wherein the operations comprise: receiving, from the differential privacy engine component, a second request for an adjustment of a select differential privacy budget associated with at least one entity of the set of entities, the adjustment being determined by the differential privacy engine component based on the differential privacy engine component's execution of the new differentially private query on the set of entities based on the differentially private query payload; and in response to the second request, adjusting the select differential privacy budget based on the adjustment requested.

In Example 7, the subject matter of Examples 1-6 includes, wherein the new differentially private query result is received from the differential privacy engine component as an output of the second stored procedure.

In Example 8, the subject matter of Examples 1-7 includes, wherein the new differentially private query result is provided to the client process as an output of the first stored procedure.

Example 9 is machine-storage storage medium, the machine-storage medium including instructions that when executed by a machine, cause the machine to perform operations to implement of any of Examples 1-8.

Example 10 is a method to implement of any of Examples 1-8.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
receiving, from a first stored procedure called by a client process, a request to execute a new differentially private query on a set of entities of a database system, the set of entities being differential privacy-protected, the new differentially private query being submitted to the client process by a user that has a differentially private query execution privilege for the set of entities and that does not have a non-differentially private query execution privilege for the set of entities;
generating a differentially private query payload based on the new differentially private query received from the first stored procedure;
causing the client process to use a second stored procedure to execute the differentially private query payload on a differential privacy engine component, the second stored procedure being configured to:
cause the differential privacy engine component to load and execute within a sandbox execution environment, the differential privacy engine component having the non-differentially private query execution privilege for the set of entities;
after the differential privacy engine component is loaded and executing in the sandbox execution environment, provide the differentially private query payload to the differential privacy engine component, the differential privacy engine component being configured to generate a new differentially private query result by executing the new differentially private query on the set of entities based on the differentially private query payload provided to the differential privacy engine component;
receiving the new differentially private query result from the differential privacy engine component; and
providing the new differentially private query result to the client process.

2. The system of claim 1, wherein the causing of the client process to use the second stored procedure to execute the differentially private query payload on the differential privacy engine comprises:
performing a system call on the client process with the differentially private query payload as a parameter of the system call, the system call being configured to cause the second stored procedure to execute on the client process with the differentially private query payload as a parameter of the second stored procedure.

3. The system of claim 1, wherein the request is a first request, and wherein the operations comprise:
receiving, from the differential privacy engine component, a second request for metadata for the set of entities, the second request being generated by the differential privacy engine component during the differential privacy engine component's execution of the new differentially private query on the set of entities based on the differentially private query payload; and
in response to the second request, providing the differential privacy engine component with the metadata for the set of entities, the differential privacy engine component being configured to execute the new differentially private query on the set of entities based on the differentially private query payload and the metadata for the set of entities.

4. The system of claim 1, wherein the request is a first request, and wherein the operations comprise:
receiving, from the differential privacy engine component, a second request for differential privacy budget information that relates to the new differentially private query, the second request being generated by the differential privacy engine component during the differential privacy engine component's execution of the new differentially private query on the set of entities; and
in response to the second request, providing the differential privacy engine component with the differential privacy budget information, the differential privacy engine component being configured to execute the new differentially private query on the set of entities based on the differentially private query payload and the differential privacy budget information.

5. The system of claim 1, wherein the operations comprise:
receiving a new non-differentially private query from the differential privacy engine component, the new non-differentially private query being generated by the differential privacy engine component based on the differentially private query payload;
generating a new non-differentially private query result by executing the new non-differentially private query on the set of entities; and
providing the new non-differentially private query result to the differential privacy engine component, the differential privacy engine component being configured to generate the new differentially private query result by adding noise to the new non-differentially private query result.

6. The system of claim 1, wherein the request is a first request, and wherein the operations comprise:
receiving, from the differential privacy engine component, a second request for an adjustment of a select differential privacy budget associated with at least one entity of the set of entities, the adjustment being determined by the differential privacy engine component based on the differential privacy engine component's execution of the new differentially private query on the set of entities based on the differentially private query payload; and
in response to the second request, adjusting the select differential privacy budget based on the adjustment requested.

7. The system of claim 1, wherein the new differentially private query result is received from the differential privacy engine component as an output of the second stored procedure.

8. The system of claim 1, wherein the new differentially private query result is provided to the client process as an output of the first stored procedure.

9. A method comprising:
receiving by a hardware processor, from a first stored procedure called by a client process, a request to execute a new differentially private query on a set of entities of a database system, the set of entities being differential privacy-protected, the new differentially private query being submitted to the client process by a user that has a differentially private query execution privilege for the set of entities and that does not have a non-differentially private query execution privilege for the set of entities;
generating, by the hardware processor, a differentially private query payload based on the new differentially private query received from the first stored procedure;
causing the client process to use a second stored procedure to execute the differentially private query payload on a differential privacy engine component, the second stored procedure being configured to:
cause the differential privacy engine component to load and execute within a sandbox execution environment, the differential privacy engine component having the non-differentially private query execution privilege for the set of entities;
after the differential privacy engine component is loaded and executing in the sandbox execution environment, provide the differentially private query payload to the differential privacy engine component, the differential privacy engine component being configured to generate a new differentially private query result by executing the new differentially private query on the set of entities based on the differentially private query payload provided to the differential privacy engine component;
receiving, by the hardware processor, the new differentially private query result from the differential privacy engine component; and
providing, by the hardware processor, the new differentially private query result to the client process.

10. The method of claim 9, wherein the causing of the client process to use the second stored procedure to execute the differentially private query payload on the differential privacy engine comprises:
performing a system call on the client process with the differentially private query payload as a parameter of the system call, the system call being configured to cause the second stored procedure to execute on the client process with the differentially private query payload as a parameter of the second stored procedure.

11. The method of claim 9, wherein the request is a first request, and wherein the method comprises:
receiving, from the differential privacy engine component, a second request for metadata for the set of entities, the second request being generated by the differential privacy engine component during the differential privacy engine component's execution of the new differentially private query on the set of entities based on the differentially private query payload; and
in response to the second request, providing the differential privacy engine component with the metadata for the set of entities, the differential privacy engine component being configured to execute the new differentially private query on the set of entities based on the differentially private query payload and the metadata for the set of entities.

12. The method of claim 9, wherein the request is a first request, and wherein the method comprises:
receiving, from the differential privacy engine component, a second request for differential privacy budget information that relates to the new differentially private query, the second request being generated by the differential privacy engine component during the differential privacy engine component's execution of the new differentially private query on the set of entities; and
in response to the second request, providing the differential privacy engine component with the differential privacy budget information, the differential privacy engine component being configured to execute the new differentially private query on the set of entities based on the differentially private query payload and the differential privacy budget information.

13. The method of claim 9, comprising:
receiving a new non-differentially private query from the differential privacy engine component, the new non-differentially private query being generated by the differential privacy engine component based on the differentially private query payload;
generating a new non-differentially private query result by executing the new non-differentially private query on the set of entities; and
providing the new non-differentially private query result to the differential privacy engine component, the differential privacy engine component being configured to generate the new differentially private query result by adding noise to the new non-differentially private query result.

14. The method of claim 9, wherein the request is a first request, and wherein the method comprises:
receiving, from the differential privacy engine component, a second request for an adjustment of a select differential privacy budget associated with at least one entity of the set of entities, the adjustment being determined by the differential privacy engine component based on the differential privacy engine component's execution of the new differentially private query on the set of entities based on the differentially private query payload; and
in response to the second request, adjusting the select differential privacy budget based on the adjustment requested.

15. The method of claim 9, wherein the new differentially private query result is received from the differential privacy engine component as an output of the second stored procedure.

16. The method of claim 9, wherein the new differentially private query result is provided to the client process as an output of the first stored procedure.

17. A machine-storage medium comprising instructions that, when executed by one or more processors of a machine, configure the machine to perform operations comprising:
receiving, from a first stored procedure called by a client process, a request to execute a new differentially private query on a set of entities of a database system, the set of entities being differential privacy-protected, the new differentially private query being submitted to the client process by a user that has a differentially private query execution privilege for the set of entities and that does not have a non-differentially private query execution privilege for the set of entities;
generating a differentially private query payload based on the new differentially private query received from the first stored procedure;
causing the client process to use a second stored procedure to execute the differentially private query payload on a differential privacy engine component, the second stored procedure being configured to:
cause the differential privacy engine component to load and execute within a sandbox execution environment, the differential privacy engine component having the non-differentially private query execution privilege for the set of entities;
after the differential privacy engine component is loaded and executing in the sandbox execution environment, provide the differentially private query payload to the differential privacy engine component, the differential privacy engine component being configured to generate a new differentially private query result by executing the new differentially private query on the set of entities based on the differentially private query payload provided to the differential privacy engine component;
receiving the new differentially private query result from the differential privacy engine component; and
providing the new differentially private query result to the client process.

18. The machine-storage medium of claim 17, wherein the causing of the client process to use the second stored procedure to execute the differentially private query payload on the differential privacy engine comprises:
performing a system call on the client process with the differentially private query payload as a parameter of the system call, the system call being configured to cause the second stored procedure to execute on the client process with the differentially private query payload as a parameter of the second stored procedure.

19. The machine-storage medium of claim 17, wherein the request is a first request, and wherein the operations comprise:
receiving, from the differential privacy engine component, a second request for metadata for the set of entities, the second request being generated by the differential privacy engine component during the differential privacy engine component's execution of the new differentially private query on the set of entities based on the differentially private query payload; and
in response to the second request, providing the differential privacy engine component with the metadata for the set of entities, the differential privacy engine component being configured to execute the new differentially private query on the set of entities based on the differentially private query payload and the metadata for the set of entities.

20. The machine-storage medium of claim 17, wherein the request is a first request, and wherein the operations comprise:
receiving, from the differential privacy engine component, a second request for differential privacy budget information that relates to the new differentially private query, the second request being generated by the differential privacy engine component during the differential privacy engine component's execution of the new differentially private query on the set of entities; and
in response to the second request, providing the differential privacy engine component with the differential privacy budget information, the differential privacy engine component being configured to execute the new differentially private query on the set of entities based on the differentially private query payload and the differential privacy budget information.
